(19) United States
(12) Patent Application Publication
(10) Pub. No.: US 2026/0067912 A1
(43) Pub. Date: Mar. 5, 2026

(54) METHODS, DEVICES, AND MEDIUM FOR COMMUNICATION

(71) Applicant: NEC Corporation, Tokyo (JP)

(72) Inventors: Peng GUAN, Beijing (CN); Yukai GAO, Beijing (CN); Gang WANG, Beijing (CN)

(73) Assignee: NEC Corporation, Tokyo (JP)

(21) Appl. No.: 18/997,731

(22) PCT Filed: Aug. 11, 2022
(86) PCT No.: PCT/CN2022/111805

§ 371 Date: Jan. 22, 2025

(51) Int. Cl. H04W 72/50

(52) U.S. Cl. CPC H04W 72/50

(57) ABSTRACT

Example embodiments of the present disclosure relate to an effective mechanism for communication. In this solution, the device determines, at a terminal device supporting a plurality of machine learning (ML) models, the respective number of ML processing resources or a respective priority for each ML model of at least one ML model being operated at the terminal device and schedules, based on the respective numbers of ML processing resources or the respective priorities, ML processing resources for the at least one ML model. In this way, the limited ML processing resource/capacity may be allocated to the most importance ML model(s).

### FIELD

Example embodiments of the present disclosure generally relate to the field of communication techniques and in particular, to methods, devices, and medium for a machine learning (ML)-assisted communication.

### BACKGROUND

As communication networks and services increase in size, complexity, and number of users, communications in the communication networks may become increasingly more complicated. In order to improve the communication performance, ML/artificial intelligence (AI) technology is proposed to be used in the wireless communication network. For example, the terminal device may use different ML model to assist communication-related functionalities, such as, multiple input multiple output (MIMO), channel state information (CSI), beam management (BM) and so on.

However, in case of MIMO and multiple ML modes, the amount of calculations at the terminal device will be sharply increased, which usually requires more computing resource and more likely to cause a high device temperature. Thus, it is expected that the restricted ML processing resources may be reasonable scheduled among the plurality of ML modes and the device temperature may be well controlled.

### SUMMARY

In general, embodiments of the present disclosure provide methods, devices and computer storage media of ML-assisted communication.

In a first aspect, there is provided a method of communication. The method comprises: determining, at a terminal device supporting a plurality of ML models, the respective number of ML processing resources or a respective priority for each ML model of at least one ML model being operated at the terminal device based on at least one factor including the following: a real-time requirement of the ML model, a latency of the ML model, a collaboration level of the ML model, a report transmission requirement of the ML model, a ML type of the ML model, the ML type being one of a two-sided ML model or a one-sided ML model, the number of entities involved in the ML model, a functionality of the ML model, a ML group which the ML model belongs to, an accuracy requirement of the ML model, or a communication protocol layer associated with the ML model. The method further comprises scheduling, based on the respective numbers of ML processing resources or the respective priorities, ML processing resources for the at least one ML model.

In a second aspect, there is provided a method of communication. The method comprises: generating, at a terminal device, an assistant information associated with at least one of the following: first information used for adjusting a specification of a ML model being operated at the terminal device, or second information used for adjusting a specification of a MIMO, the second information associated with at least one of the following: a measurement specification of the MIMO, a computation specification of the MIMO, or a maintenance specification of the MIMO. The method further comprises transmitting, the assistant information to the network device.

In a third aspect, there is provided a method of communication. The method comprises: predicting at a terminal device, a temperature change in a subsequent period. The method further comprises determining assistant information if the temperature change meets a adjust condition, the assistant information used for relieving the temperature change in the subsequent period. The method also comprises transmitting the assistant information to a network device.

In a fourth aspect, there is provided a method of communication. The method comprises: receiving, at a network device and from a terminal device, an assistant information associated with at least one of the following: first information used for adjusting a specification of a ML model being operated at the terminal devoice, or second information used for adjusting a specification of a MIMO.

In a fifth aspect, there is provided a method of communication. The method comprises: receiving, at a network device, assistant information from a terminal device, the assistant information, wherein, the assistant information is transmitted by the terminal device in response to detecting a predicted temperature change meets a adjust condition and is used for relieving a temperature change of the terminal device in the subsequent period.

In a sixth aspect, there is provided a first device. The terminal device includes a processing unit; and a memory coupled to the processing unit and storing instructions thereon, the instructions, when executed by the processing unit, causing the device to perform the method according to the first aspect.

In a seventh aspect, there is provided a terminal device. The terminal device includes a processing unit; and a memory coupled to the processing unit and storing instructions thereon, the instructions, when executed by the processing unit, causing the device to perform the method according to the second aspect.

In an eighth aspect, there is provided a first device. The terminal device includes a processing unit; and a memory coupled to the processing unit and storing instructions thereon, the instructions, when executed by the processing unit, causing the device to perform the method according to the third aspect.

In a ninth aspect, there is provided a second device. The network device includes a processing unit; and a memory coupled to the processing unit and storing instructions thereon, the instructions, when executed by the processing unit, causing the device to perform the method according to the fourth aspect.

In a tenth aspect, there is provided a second device. The network device includes a processing unit; and a memory coupled to the processing unit and storing instructions thereon, the instructions, when executed by the processing unit, causing the device to perform the method according to the fifth aspect.

In an eleventh aspect, there is provided a computer readable medium having instructions stored thereon, the instructions, when executed on at least one processor, causing the at least one processor to carry out the method according to any of the above first to fifth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates results of degradation according correlated with device temperature;

FIG. 1B illustrates results of correlation of throughput with number of NR channels;

FIG. 1C illustrates comparation results between using ice bag and without using ice bag;

FIG. 2A illustrates an example communication environment in which example embodiments of the present disclosure can be implemented;

FIG. 2B illustrates a signaling chart illustrating a process for communication according to some embodiments of the present disclosure;

FIG. 3 illustrates an example method performed by the terminal device according to some embodiments of the present disclosure;

FIG. 4 illustrates another example method performed by the terminal device according to some embodiments of the present disclosure;

FIG. 5 illustrates a further example method performed by the terminal device according to some embodiments of the present disclosure;

FIG. 6 illustrates an example method performed by the network device according to some embodiments of the present disclosure;

FIG. 7 illustrates another example method performed by the network device according to some embodiments of the present disclosure; and

FIG. 8 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or cNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The mm Wave band communication and MIMO are identified as key features for the wireless communication. Further, the ML/AI technology is proposed to be used in the wireless communication network, where the AI/ML model/functionality (such as, AI/ML model used for air-interface) may be deployed at the terminal side. However, in case of MIMO and multiple ML modes, the amount of calculations at the terminal device will be sharply increased, which usually requires more computing resources and more likely to cause a high device temperature.

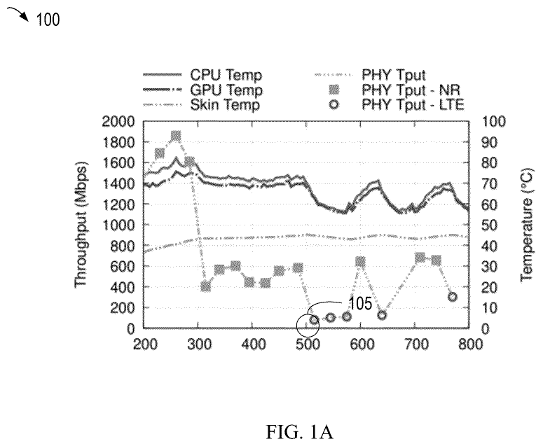

FIGS. 1A and 1B illustrate representative results 100 and 120 of through degradation according to the device temperature at a terminal device. Specifically, FIG. 1A illustrates results 100 of degradation according correlated with device temperature, and FIG. 1B illustrates results 120 of correlation of throughput with number of NR channels. As can be seen from FIG. 1A and FIG. 1B, at time point 125 of FIG. 1B (i.e., 300 second), the number of 5G mm Wave channels is reduced from 4 to 1, and at time point 105 of FIG. 1A (i.e., 500 second), the terminal device is handed over from NR to the LTE network. Further, at both time point of 125 (i.e., 300 second) and time point of 125 (i.e., 500 second), signaling packet of secondary cell group (SCG) failure is identified.

Further, consider using a physical measure (i.e., cover the terminal device with an ice bag) to control the device temperature. Reference is now made to FIG. 1C, which illustrates comparation results 160 between using ice bag and without using ice bag. As can be seen from FIG. 1C, in case of using ice bag (i.e. controlling the device temperature), the throughput of the terminal device may be maintained at the relative stable level without a sharp drop. In view of the above, the high device temperature is a main factor responsible for the throughput decreasing.

However, using the ice bag is not an implementable solution. Thus, it is expected to propose an implementable solution which may avoid a high device temperature without compromising communication performance.

According to the example embodiments of the present discourse, the terminal device may perform at least one of: scheduling the restricted ML processing resources based on different priorities for different ML modes, adjusting the specification(s) of MIMO and/or ML models, adopting adaptive configurations associated with different device temperatures, such that the restricted ML processing resources may be reasonable scheduled among the plurality of ML modes and/or the device temperature may be well controlled without compromising communication performance.

In the following text, merely for better understanding a terminal device and a network device would be used as examples when discussing the specific embodiments. It should be understood that the embodiments described herein may be implemented among any suitable network elements unless there is a clear literal statement. Specifically, either the terminal device or the network device may be replaced by the other device type.

As used herein, the term “model” is referred to as an association between an input and an output learned from training data, and thus a corresponding output may be generated for a given input after the training. The generation of the model may be based on a ML technique. The ML techniques may also be referred to as AI techniques. In general, a ML model can be built, which receives input information and makes predictions based on the input information.

Further, for better understanding, some terminologies related with ML model are described in below table 1.

TABLE 1
descriptions of terminology

| Terminology | Description |
|---|---|
| Data collection | A process of collecting data by the network nodes, |
| | management entity, or UE for the purpose of AI/ML model |
| | training, data analytics and inference. |
| AI/ML Model | A data driven algorithm that applies AI/ML techniques to |
| | generate a set of outputs based on a set of inputs. |
| AI/ML model training | A process to train an AI/ML Model [by learning the |
| | input/output relationship] in a data driven manner and obtain |
| | the trained AI/ML Model for inference. |
| AI/ML model Inference | A process of using a trained AI/ML model to produce a set of |
| | outputs based on a set of inputs. |
| AI/ML model validation | A subprocess of training, to evaluate the quality of an AI/ML |
| | model using a dataset different from one used for model |
| | training, that helps selecting model parameters that generalize |
| | beyond the dataset used for model training. |
| AI/ML model testing | A subprocess of training, to evaluate the performance of a |
| | final AI/ML model using a dataset different from one used for |
| | model training and validation. Differently from AI/ML model |
| | validation, testing does not assume subsequent tuning of the |
| | model. |
| UE-side (AI/ML) model | An AI/ML Model whose inference is performed entirely at the |
| | UE. |
| Network-side (AI/ML) | An AI/ML Model whose inference is performed entirely at the |
| model | network. |
| One-sided (AI/ML) model | A UE-side (AI/ML) model or a Network-side (AI/ML) model |
| Two-sided (AI/ML) model | A paired AI/ML Model(s) over which joint inference is |
| | performed, where joint inference comprises AI/ML Inference |
| | whose inference is performed jointly across the UE and the |
| | network, i.e, the first part of inference is firstly performed by |
| | UE and then the remaining part is performed by gNB, or vice |
| | versa. |
| AI/ML model transfer | Delivery of an AI/ML model over the air interface, either |
| | parameters of a model structure known at the receiving end or |
| | a new model with parameters. Delivery may contain a full |
| | model or a partial model. |
| Model download | Model transfer from the network to UE. |
| Model upload | Model transfer from UE to the network. |
| Federated learning / | A machine learning technique that trains an AI/ML model |
| federated training | across multiple decentralized edge nodes (e.g., UEs, gNBs) |
| | each performing local model training using local data |
| | samples. The technique requires multiple interactions of the |
| | model, but no exchange of local data samples. |
| Offline field data | The data collected from field and used for offline training of |
| | the AI/ML model. |
| Online field data | The data collected from field and used for online training of |
| | the AI/ML model |
| Model monitoring | A procedure that monitors the inference performance of the |
| | AI/ML model. |
| Supervised learning | A process of training a model from input and its |
| | corresponding labels. |
| Unsupervised learning | A process of training a model without labelled data. |
| Semi-supervised learning | A process of training a model with a mix of labelled data and |
| | unlabelled data. |
| Reinforcement Learning | A process of training an AI/ML model from input (a.k.a. state) |
| (RL) | and a feedback signal (a.k.a. reward) resulting from the |
| | model's output (a.k.a. action) in an environment the model is |
| | interacting with. |
| Model activation | Enable an AI/ML model for a specific function. |
| Model deactivation | Disable an AI/ML model for a specific function. |
| Model switching | Deactivating a currently active AI/ML model and activating a |
| | different AI/ML model for a specific function. |

In the present disclosure, terms “ML model”, “AI model”, “ML function”, “AI function” and “algorithm” may be used interchangeably.

### Example Environment

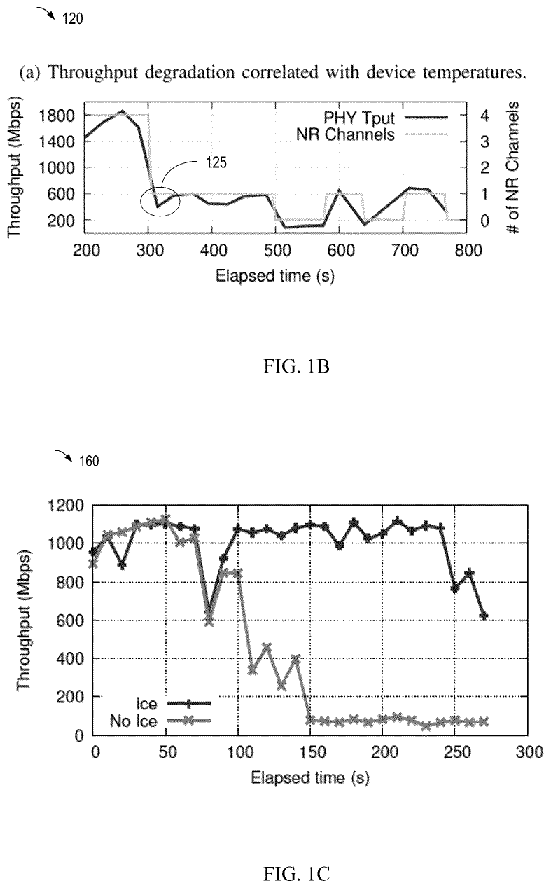

FIG. 2A shows an example communication environment 200 in which example embodiments of the present disclosure can be implemented.

The communication environment 200 includes a network device 210 and a terminal device 220, and further the network device 210 can communicate with the terminal device 220 via physical communication channels or links.

In the specific example of communication environment 200, a link from the terminal device 220 to the network device 210 is referred to as uplink, while a link from the network device 210 to the terminal device 220 is referred to as a downlink. Further, MIMO is supported in the communication environment 200, such that the network device 210 and the terminal device 220 may communicate with each other via different beams to enable a directional communication. In downlink, the network device 210 is a transmitting (TX) device (or a transmitter) and the terminal device 220 is a receiving (RX) device (or a receiver), and the network device 210 may transmit downlink transmission to the terminal device 220 via one or more beams. As illustrated in FIG. 2A, the network device 210 transmits downlink transmission to the terminal device 220 via the beams 240-1 to 240-3.

Correspondingly, in uplink, the network device 210 is a RX device (or a receiver) and the terminal device 220 is a TX device (or a transmitter), and the terminal device 220 may transmit uplink transmission to the network device 210 via one or more beams. As illustrated in FIG. 2A, the terminal device 220 transmits uplink transmission to the network device 210 via the beams 230-1 to 230-3. For purpose of discussion, the beams 230-1 to 230-3 or beams 240-1 to 240-3 are collectively or individually referred to as beam 230 or beam 240, respectively.

It is to be understood that the number of devices and their connections in FIG. 2A are given for the purpose of illustration without suggesting any limitations to the present disclosure. The communication environment 200 may include any suitable number of network devices and/or terminal devices adapted for implementing implementations of the present disclosure.

In some embodiments, the terminal device 220 and the network device 210 may communicate with each other via a channel such as a wireless communication channel on an air interface (e.g., Uu interface). The wireless communication channel may comprise a PUCCH, a PUSCH, a physical random-access channel (PRACH), a physical downlink control channel (PDCCH), a PDSCH and a physical broadcast channel (PBCH). Of course, any other suitable channels are also feasible.

The communications in the communication environment 200 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, a plurality of ML modes may be deployed at the terminal device 220. According to some example embodiments of the present discourse, the terminal device 220 may take some measures to schedule the restricted ML processing resources and/or control the device temperature. FIG. 2B illustrates a signaling chart illustrating a process 250 for communication according to some embodiments of the present disclosure. For the purpose of discussion, the process 250 will be described with reference to FIG. 2A. The process 250 may involve the terminal device 220 and the network device 210.

As illustrated in FIG. 2B, in some example embodiments, the terminal device 220 and the network device 210 may optionally exchange 252 capability-related information with each other. In the specific example FIG. 2B, the terminal device 220 may determine 254 one or more priorities for the ML mode(s) and/or the number of ML processing resources for each ML model, and further schedule 255 the ML processing resources for the ML models. In addition to the above, a coordination interaction may be performed 256 between the terminal device 220 and the network device 210. Specifically, the terminal device 220 may transmit 260 assistant information to the network device 210 and optionally receive 270 the adjust configuration from the network device 210. The details of these measures will be discussed in detail in the following portion of the present discuses.

In some embodiments, the assistant information may be transmitted as UE assistance information (UAI). As one specific embodiments, the assistant information may be included in an information element (IE) of OverheatingAssistance.

In some embodiments, the assistant information (i.e., the UAI) may include any suitable parameters which may be used for device management and communication. Example parameters, include but are not limited to,
delay budget report carrying desired increment/decrement in the connected mode discontinuous reception (DRX) cycle length, or;
overheating assistance information, or;
in-device coexistence interference avoidance (IDC) assistance information, or;
preference on DRX parameters for power saving, or;
preference on the maximum aggregated bandwidth for power saving, or;
preference on the maximum number of secondary component carriers for power saving, or;
preference on the maximum number of MIMO layers for power saving, or;
preference on the minimum scheduling offset for cross-slot scheduling for power saving, or;
preference on the RRC state, or;
configured grant assistance information for NR sidelink communication, or;
preference in being provisioned with reference time information, or;
preference for Frequency Range 2 (FR2) uplink gap, or;
preference to transition out of RRC_CONNECTED state for MUSIM operation, or;
preference on the MUSIM gaps, or;
relaxation state for Radio link monitoring (RLM) measurements, or;
relaxation state for beam failure detection (BFD) measurements, or;
availability of data mapped to radio bearers which are not configured for small data transmission (SDT), or;
preference for the SCG to be deactivated, or;
indicate that the UE has uplink data to transmit for a Data Radio Bearer (DRB) for which there is no master cell group (MCG) radio link control (RLC) bearer while the SCG is deactivated, or;
change of fulfilment status for Radio Resource Management (RRM) measurement relaxation criterion.

In some embodiments, the assistant information is transmitted by the terminal device 220 which is capable of providing the assistance information and is in RRC_CONNECTED state, upon detecting a report condition is met, such as, detecting internal overheating or detecting that it is no longer experiencing an overheating condition.

In some embodiments, the UEAssistanceInformation message may be used for the indication of assistance information to the network device 210. As one example, if the assistant information transmission procedure is initiated, the terminal device 220 may:
if configured to provide overheating assistance information:
   if the overheating condition has been detected and a report timer (such as, T345) is not running; or
   if the current overheating assistance information is different from the one indicated in the last transmission of the UEAssistanceInformation message including overheatingAssistance and timer T345 is not running:
      start timer T345 with the timer value set to the overheatingIndicationProhibitTimer;
      initiate transmission of the UEAssistanceInformation message to provide overheating assistance information

Merely for better understanding, two examples of part of the IE OverheatingAssistance are illustrated as below.

One examples of part of the IE OverheatingAssistance

```
OverheatingAssistance ::= SEQUENCE {
  reducedMaxCCs ReducedMaxCCs-r16 OPTIONAL,

[symbol]

OverheatingAssistance-r17 ::= SEQUENCE {
  reducedMaxBW-FR2-2-r17 SEQUENCE {
    reducedBW-FR2-2-DL-r17 ReducedAggregatedBandwidth-r17
    OPTIONAL,
    reducedBW-FR2-2-UL-r17 ReducedAggregatedBandwidth-r17
    OPTIONAL
  } OPTIONAL,
  reducedMaxMIMO-LayersFR2-2 SEQUENCE {
    reducedMIMO-LayersFR2-2-DL MIMO-LayersDL,
    reducedMIMO-LayersFR2-2-UL MIMO-LayersUL
  } OPTIONAL
} [symbol]
indicates data missing or illegible when filed
```

Another examples of part of the IE OverheatingAssistance

In the above specific embodiments, parameter “reducedBW-FR2” may be reported. Parameter “reducedBW-FR2” indicates the preference on reduced configuration for the terminal device 220, the preference corresponding to the maximum aggregated bandwidth across all downlink carrier(s) and across all uplink carrier(s) of FR2-1. In this way, overheating may be avoided, and power saving may be achieved. Additionally, in some embodiments, this field is allowed to be reported only when the terminal device 220 is configured with serving cell(s) operating on FR2-1.

Additionally, in some embodiments, the aggregated bandwidth across all downlink carrier(s) of FR2-1 is the sum of bandwidth of active downlink bandwidth part(s), BWP(s), across all activated downlink carrier(s) of FR2-1, and the aggregated bandwidth across all uplink carrier(s) of FR2 is the sum of bandwidth of active uplink BWP(s) across all activated uplink carrier(s) of FR2-1.

In some embodiments, if the field is absent from the IE MaxBW-Preference or the IE OverheatingAssistance, it is interpreted as the terminal device 220 having no preference on the maximum aggregated bandwidth of FR2-1. Accordingly, when indicated to address overheating, this maximum aggregated bandwidth includes carrier(s) of FR2 of both the NR master cell group (MCG) and the NR SCG. In some embodiments, this maximum aggregated bandwidth only includes carriers of FR2-1 of the SCG in (NG) EN-DC.

In some embodiments, when indicated to address power saving, this maximum aggregated bandwidth includes carrier(s) of FR2-1 of the cell group that this UE assistance information is associated with. Additionally, in some embodiments, the aggregated bandwidth can only range up to the current active configuration when indicated to address power savings.

### Example Processes

It should be understood that although feature(s)/operation(s) are discussed in specific example embodiments separately, unless clearly indicated to the contrary, these feature(s)/operation(s) described in different example embodiments may be used in any suitable combination.

In addition, in the following description, some interactions are performed among the terminal device 220 and the network device 210 (such as, exchanging capability-related information, assistant information, configuration(s) and so on). It is to be understood that the interactions may be implemented either in one single signaling/message or multiple signaling/messages, including system information (SI), radio resource control (RRC) message, downlink control information (DCI) message, uplink control information (UCI) message, media access control (MAC) control element (CE) and so on. The present disclosure is not limited in this regard.

As discussed above, the device temperature should be well controlled. In some embodiments, the terminal device 220 may request to lower transmission specifications when experiencing high temperature, such as, reducing MIMO layers, transmission bandwidth and the likes, which directly result a low data transmission rate/throughout. However, in the actual communication environment, in addition to data transmission itself, operations of measurement, computation and maintenance also requires quite high resource consumptions, which should also be considered as key factors that influence the device temperature. Further, the introduction of AI/ML model for air-interface at device would also consume a lot of resources and may make the overheating issue worse.

In summary, in the actual communication environment, the device temperature is influenced by a plurality of factors, include but are not limited to,
Environmental factors: such as, seasons (summer/winter), time periods (day/night), environment temperature and so on.
Communication-related factors: such as, high data rate requirement, frequent measurement, intensive baseband/IF/RF processing and so on.
Non-communication-related factors, such as, resource-consuming applications running on the terminal device, for example, video, extended reality (XR)/augmented reality (AR)/game, rendering task and so on, which may arise a high data rate requirement if they require an online processing.
AI/ML-related factors (in case that AI/ML functionality is deployed): such as, AI/ML for communication functions (for example, AI for air-interface), AI/ML for non-communication functions (for example, AI for photo/video/gaming) and so on.

In the present discourse, the above factors will be considered more comprehensively. In the following text, examples for scheduling ML resources and controlling device temperature will be discussed in detail.

### Processes for Scheduling ML Processing Resources

The following processes for scheduling ML processing resources will be discussed with reference to FIGS. 2A and 2B.

In some embodiments, optionally, the terminal device 220 may report 252 a maximum ML processing capability supported by the terminal device 220 as a UE capability.

In some embodiments, in order to achieve a finer control of ML processing resource scheduling, the ML processing resources may be identified by a plurality of artificial intelligence (AI) processing units (APU).

In some embodiments, APU is considered as a logic concept, which may further be represented by other metric of evaluating AI computation power. In one specific example embodiment, one APU may correspond to a certain amount physical resource, such as, the number of operations Per Second (OPS), floating point operations per second (FLOPS) and so on, for example, 1 APU=1 Tera OPS (TOPS).

In some embodiments, the number of APUs supported by the terminal device 220 simultaneously or supported within a time duration (be represented as N_{APU}) may be reported as a UE capability (i.e., the maximum ML processing capability).

It is to be understood that the time duration may be measured by any suitable time unit, including but not limited to a second, a millisecond, a frame, a slot, a OFDM symbol, and so on.

In some embodiments, the terminal device 220 supports a plurality of ML models and at least one ML model is currently operated at the terminal device 220. In order to reasonably schedule the ML processing resources, the terminal device 220 determines 254 a respective priority for each ML model of the ML model(s) being operated at the terminal device 220, and schedules 256 the ML processing resources based on the determined priorities. In this way, the limited ML processing resources/capacities at the terminal device 220 side may be allocated to the most importance ML model(s).

In some embodiments, the priorities are determined based on at least one factor. Additionally, the priorities may be determined based on at least one rule.

In some embodiments, the at least one rule is pre-defined. As one example, the at least one rule is pre-defined by the communication organization (such as 3GPP), or pre-defined by the network operator or service provider. In this way, the least one rule may be applied as a default configuration and no additional signaling exchanging between the terminal device and the network device 210 is needed.

Alternatively, in some embodiments, the at least one rule may be dynamically or semi-statically configured. For example, either the terminal device 220 or the network device 210 may determine the at least one rule and then inform at least one rule to the other device.

Additionally, in some embodiments, the at least one rule is common with regards to the terminal device 220 and at least one further terminal device. Alternatively, in some embodiments, the at least one rule is specific to the terminal device 220. In this way, the priority rule is more flexible and further may be a customed configuration.

In the following example factors and rules for determining the priorities will be discussed.

Generally speaking, for real-time ML model, the output may impact the followed-up transmissions immediately, thus it should be processed firstly. In view of this, in some embodiments, the factor for determining the priorities is a real-time requirement of the ML model. Specifically, if the first ML model is a real-time ML model and the second ML model is a non-real-time ML model, a first priority of the first ML model is higher than a second priority of the second ML model. Merely for better understanding, one example of real-time ML model is ML model for demodulation, and one example of non-real-time ML model: ML model for mobility.

Alternatively, or in addition, in some embodiments, the factor for determining the priorities may be a latency of the ML model. Specifically, if the first ML model requires a lower latency compared with the second ML model, a first priority of the first ML model is higher than a second priority of the second ML model. Merely for better understanding, examples of ML model with low latency include: ML model for ultra-reliable low-latency communications (URLLC) and ML model for XR, and one example of ML model with non-low latency is ML for enhanced mobile broadband (cMBB).

Alternatively, or in addition, in some embodiments, the factor for determining the priorities may be a collaboration level of the ML model. Specifically, if the first ML model requires a higher collaboration level compared with the second ML model, a first priority of the first ML model is higher than a second priority of the second ML model.

In one specific example, the collaboration level may be one of: level x: no collaboration, level y: signaling-based collaboration without model transfer, level z: signaling-based collaboration with model transfer. Additionally, the priority from high to low may be {level z, level y, level x}.

Generally speaking, if UE report is based on AI/ML model output, thus it should be processed firstly. In view of this, in some embodiments, the factor for determining the priorities may be a report transmission requirement of the ML model. Specifically, if the first ML model requires a report transmission, and the second ML model does not require a report transmission, a first priority of the first ML model is higher than a second priority of the second ML model.

In summary, the factor for determining the priorities may be one or more specific actions of an actor corresponds to the ML model, where the actor is a function that receives the output from the model inference function and triggers or performs corresponding action. In the other embodiments, other actions may be used for determining the priorities based on the teaching of the above discussed example embodiments, it is to be understood that such modified embodiment should also be considered within the scope of this disclosure.

Alternatively, or in addition, in some embodiments, the factor for determining the priorities may be a ML type, where the ML type is one of a two-sided ML model or a one-sided ML model. Specifically, if an ML type of the first ML model is two-sided ML model and an ML type of the second ML model is one-sided ML model, a first priority of the first ML model is higher than a second priority of the second ML model. Merely for better understanding, one example of two-sided ML model is CSI transmission, where CSI compression is performed at the terminal device 220 and CSI recovery is performed at the network device 210.

Alternatively, or in addition, in some embodiments, the factor for determining the priorities may be the number of entities involved in the ML model. Specifically, if the number of entities involved in the first ML model is larger than the number of entities involved in the second ML model, a first priority of the first ML model is higher than a second priority of the second ML model. In other words, the priority increases as the number of entities involved in the ML model, such that the ML model involves more entities could be processed firstly.

Alternatively, or in addition, in some embodiments, the factor for determining the priorities may be a functionality of the ML model. Merely for better understanding, the rule may stipulate that a ML model for BM has a high priority compare with a ML model for CSI.

Alternatively, in some embodiments, the rule may stipulate that a ML model for reference signal receiving power (RSRP) has a higher priority than a ML model not for RSRP.

Alternatively, or in addition, in some embodiments, the factor for determining the priorities may be a ML group which the ML model belongs to. Specifically, different ML groups/lists may be identified by different model group IDs/model list IDs, and different ML models belong to the same model group/list may be identified by the same model group ID/model list ID. Further, a model group/list may correspond to a specific function. The priority of the ML model may be determined based on the different model group IDs/model list IDs and optional model IDs.

Alternatively, or in addition, in some embodiments, the factor for determining the priorities may be a correlation of communication. Specifically, if the first ML model is a communication-related ML model and the second ML model is a communication-irrelevant ML model, a first priority of the first ML model is higher than a second priority of the second ML model. Examples of non-communication-related ML modes comprise a ML model for positioning, a ML model for photo, a ML model for video.

Alternatively, or in addition, in some embodiments, the factor for determining the priorities may be an accuracy requirement of the ML model. Specifically, if the first ML model requires a higher accuracy (such as, an accuracy of prediction) compared with the second ML model, a first priority of the first ML model is higher than a second priority of the second ML model.

Alternatively, or in addition, in some embodiments, the factor for determining the priorities may be a communication protocol layer associated with the ML model. In one specific example embodiment, the communication protocol layer maybe identified according to OSI model, such as, a physical layer, a data link layer, a network layer, and so on. Alternatively, in another one specific example embodiment, the communication protocol layer may be identified according to the classification of radio access network (RAN), such as, RAN1-related, RAN2-related, RAN3-related and so on.

It should be appreciated that the above factors are given for the purpose of illustration without suggesting any limitations. The terminal device 220 may determine the priority for the ML model bases on any suitable factors. Further, the above factors and the other suitable factors may be used separately or in combination.

Additionally, in case that more than one factor is used for determining the priority, different factors may be configured with different weights. In one specific example embodiment, the weights of the factors can be sorted by a certain order, for example, {latency, collaboration level, accuracy, . . . }. In this way, different factors may have different contributions when determining the priority, and the priority rule may be defined more reasonable.

In one specific example embodiment, a priority value may be calculated by below equation (1).

$$priority ( ML model ) = Ma * a + Mb * b + Mc * c + Md * d + Me * e … \qquad ( 1 )$$

where, a=0 or 1, used for indicating real-time ML model and non-real-time ML model respectively;
b=0 or 1 or 2, used for indicating different collaboration levels, respectively;
c=0 or 1. used for indicating the ML type of the ML model, such as value 0 for two-sided ML model and value “1” for one-sided ML model;
d may be the model ID;
e may be the model group ID;
Ma, Mb, Mc, Md, Me are coefficients separating the impacts of different factors. i.e., the weights.

In addition, a smaller priority value means a higher priority. In other words, a ML model with a smaller priority value has a higher priority than a ML model with a larger priority value.

It is to be understood that the above equation (1) is illustrated merely for the purpose of illustration without suggesting any limitations. In the other embodiments, the priority may be calculated by any suitable equations. The present discourse is not limited in the regard.

In addition or alternatively to the priority, the terminal device 220 also may determine respective number of ML processing resources for each ML model being operated at the terminal device 220, and then schedule the ML processing resources based on the respective numbers of ML processing resources.

Similar with determining the priority, the respective number of ML processing resources for one ML model also may be determined based on at least one factor and/or at least one rule.

Additionally, similar with the rule for determining the priority, the rule for determining the respective number of ML processing resources for one ML model also may be pre-defined, or dynamically or semi-statically configured. Further, the rule for determining the respective number of ML processing resources for one ML model also may be common with regards to the terminal device 220 and at least one further terminal device, or is specific to the terminal device 220.

Some details for determining the respective number of ML processing resources for one ML model are discussed blow.

In some embodiments, the factor for determining the number of ML processing resources for one ML model is a real-time requirement of the ML model. Specifically, if the first ML model is a real-time ML model and the second ML model is a non-real-time ML model, a first number of ML processing resources for the first ML model is larger than a second ML processing resources for the second ML model. Merely for better understanding, one example of real-time ML model is ML model for demodulation, and one example of non-real-time ML model: ML model for mobility.

Alternatively, or in addition, in some embodiments, the factor for determining the number of ML processing resources for one ML model may be a latency of the ML model. Specifically, if the first ML model requires a lower latency compared with the second ML model, a first number of ML processing resources for the first ML model is larger than a second ML processing resources for the second ML model. Merely for better understanding, examples of ML model with low latency include: ML model for URLLC, ML model for XR, and one example of ML model with non-low latency is ML for mobility.

Alternatively, or in addition, in some embodiments, the factor for determining the number of ML processing resources for one ML model may be a collaboration level of the ML model. Specifically, if the first ML model requires a higher collaboration level compared with the second ML model, a first number of ML processing resources for the first ML model is larger than a second ML processing resources for the second ML model.

In one specific example, the collaboration level may be one of: level x: no collaboration, level y: signaling-based collaboration without model transfer, level z: signaling-based collaboration with model transfer. Additionally, the number of ML processing resources from more to less may be {level z, level y, level x}.

Generally speaking, if UE reports is based on AI/ML model output, thus it should be more important. In view of this, in some embodiments, the factor for determining the number of ML processing resources for one ML model may be a report transmission requirement of the ML model. Specifically, if the first ML model requires a report transmission, and the second ML model does not require a report transmission, a first number of ML processing resources for the first ML model is larger than a second ML processing resources for the second ML model.

Alternatively, or in addition, in some embodiments, the factor for determining the number of ML processing resources for one ML model may be a ML type of the ML model, where the ML type is one of a two-sided ML model or a one-sided ML model. Specifically, if an ML type of the first ML model is two-sided ML model, and an ML type of the second ML model is one-sided ML model, a first number of ML processing resources for the first ML model is larger than a second ML processing resources for the second ML model. Merely for better understanding, one example of two-sided ML model is CSI transmission, where CSI compression is performed at the terminal device 220 and CSI recovery is performed at the network device 210.

Alternatively, or in addition, in some embodiments, the factor for determining the number of ML processing resources for one ML model may be the number of entities involved in the ML model. Specifically, if the number of entities involved in the first ML model is larger than the number of entities involved in the second ML model, a first number of ML processing resources for the first ML model is larger than a second ML processing resources for the second ML model. In other words, the number of ML resources increases as the number of entities involved in the ML model, such that the ML model involves more entities could be processed firstly.

Alternatively, or in addition, in some embodiments, the factor for determining the number of ML processing resources for one ML model may be a functionality of the ML model. As one specific embodiment, the rule may stipulate that a ML model for BM may be allocated more processing resources compared with a ML model for CSI. As another specific embodiment, the rule may stipulate a correspondence between a functionality of the ML model and the number of ML processing resources. For example, the rule may stipulate:
a first number of ML processing resources K1 corresponding to an ML model for CSI compressions;
a second number of ML processing resources K2 corresponding to an ML model for spatial-domain beam prediction;
a third number of ML processing resources K3 corresponding to an ML model for time-domain beam prediction;
a fourth number of ML processing resources K4 corresponding to an ML model for LOS/NLOS differentiation;
a fifth number of ML processing resources K5 corresponding to an ML model for mobility;
a sixth number of ML processing resources K6 corresponding to an ML model for demodulation.

In some embodiments, the terminal device 220 may report the above stipulated number to the network device 210 as UE capability.

Alternatively, or in addition, in some embodiments, the factor for determining the number of ML processing resources for one ML model may be a ML group which the ML model belongs to. Specifically, different ML groups/lists may be identified by different model group IDs/model list IDs, different ML models belong to the same model group list may be identified by the same model group ID/model list ID. Further, a model group/list m may correspond to a specific function. The number of ML processing resources of the ML model may be determined based on the different model group IDs/model list IDs and optional model IDs.

Alternatively, or in addition, in some embodiments, the factor for determining the number of ML processing resources for one ML model may be a correlation of communication. Specifically, if the first ML model is a communication-related ML model and the second ML model is communication-irrelevant ML model, a first number of ML processing resources for the first ML model is larger than a second ML processing resources for the second ML model. Examples of non-communication-related ML modes comprises a ML model for positioning, a ML model for photo, a ML model for video.

Alternatively, or in addition, in some embodiments, the factor for determining the number of ML processing resources for one ML model may be an accuracy requirement of the ML model. Specifically, if the first ML model requires a higher accuracy (such as, an accuracy of prediction) compared with the second ML model, a first number of ML processing resources for the first ML model is larger than a second ML processing resources for the second ML model.

Alternatively, or in addition, in some embodiments, the factor for determining the number of ML processing resources for one ML model may be a communication protocol layer associated with the ML model. In one specific example embodiment, the communication protocol layer maybe identified according to OSI model, such as, physical layer, data link layer, network layer, and so on. Alternatively, in another one specific example embodiment, the communication protocol layer maybe identified according to the classification of radio access network (RAN), such as, RAN1-related, RAN2-related, RAN3-related and so on.

Alternatively, or in addition, in some embodiments, the factor for determining the number of ML processing resources for one ML model may be an input size of the ML model. Specifically, the rule may stipulate a correspondence between the number of ML processing resources and an input size (which may be a value or a vale range). In one specific example, a first number of ML processing resources corresponds to a first input size range, while a second number of ML processing resources corresponds to a second input size range.

Additionally, the correspondence between the number of ML processing resources and an input size may follow a pre-defined function, including but not limited to a proportional function (for example, there is a fixed ratio between the number of ML processing resources and the input size).

Additionally, in one specific example embodiment, the input size of the ML model associates with at least one of the following:
a size of precoding matrix indicators (PMIs) for channel state information (CSI), as an input of the ML model,
a size of channel matrix for CSI, as an input of the ML model, or
the number of measurement instances for the CSI, as an input of the ML model; such as, the number of latest measurement instances used as input for CSI.

In the above specific example embodiment, different numbers of ML processing resources may correspond to different sizes of PMIs for CSI, different sizes of channel matrix for CSI or different numbers of measurement instances for the CSI. In this way, in case that when using a ML model for CSI, the ML processing resources may be feasibly allocated for the ML model.

Alternatively, or in addition, in another embodiment, the input size of the ML model associates with the number of measurement beams or measurement instances for a beam management, such as, the number of latest measurement instances used as input for BM. In this specific example embodiment, different numbers of ML processing resources may correspond to different numbers of measurement beams or measurement instances for a beam management. In this way, in case that when using a ML model for beam management, the ML processing resources may be feasibly allocated for the ML model.

It is to be understood that the above examples of input size are only for the purpose of illustration without suggesting any limitations. In the other embodiments, the ML model may be used for other functionality, and the input sizes may be changed according to the related input parameters. The present disclosure is not limited in this regard.

Alternatively, or in addition, in some embodiments, the factor for determining the number of ML processing resources for one ML model may be an output size of the ML model. Specifically, the rule may stipulate a correspondence between the number of ML processing resources and an output size (which may be a value or a vale range). In one specific example, a first number of ML processing resources corresponds to a first output size range, while a second number of ML processing resources corresponds to a second output size range.

Additionally, the correspondence between the number of ML processing resources and an output size may follow a pre-defined function, including but not limited to a proportional function (for example, there is a fixed ratio between the number of ML processing resources and the output size).

Additionally, in one specific example embodiment, the output size associates with at least one of the following:
the number of compressed bits for the CSI, as an output of the ML model,
the number of prediction instances for the CSI, as an output of the ML model; such as, number of F predictions for F future time instances.

In the above specific example embodiment, different numbers of ML processing resources may correspond to different numbers of compressed bits for the CSI, or different numbers of prediction instances for the CSI. In this way, in case that when using a ML model for CSI, the ML processing resources may be feasibly allocated for the ML model.

Alternatively, or in addition, in some embodiments, the output size associates with the number of predicted beams or predicted instances for the beam management, as an output of the ML model (such as, number of F predictions for F future time instances). In this way, in case that when using a ML model for beam management, the ML processing resources may be feasibly allocated for the ML model.

It is to be understood that the above examples of input output are only for the purpose of illustration without suggesting any limitations. In the other embodiments, the ML model may be used for other functionality, and the output sizes may be changed according to the related output parameters. The present disclosure is not limited in this regard.

Alternatively, or in addition, in some embodiments, the factor for determining the number of ML processing resources for one ML model may be a stage of life-cycle management at which the ML model is currently operated.

In some embodiments, the stage of life-cycle management may be one of the following: ML model deployment, performance monitoring, feedback, update and other stages of life-cycle management.

Alternatively, or in addition, in some embodiments, the factor for determining the number of ML processing resources for one ML model may be a phase of an ML model.

In some embodiments, the phase of the ML model is one of the following: a training phase, a validation phase, a testing phase, or an inference phase. As one specific example embodiment, the rule may stipulate the number of ML processing resources increases according to the order of {an inference phase, a validation phase, a testing phase, a training phase}.

Alternatively, or in addition, in some embodiments, the factor for determining the number of ML processing resources for one ML model may be a structure of the ML model. Examples of the structure of the ML model comprises convolutional neural network (CNN), recurrent neural network (RNN), transformer, inception. Specifically, the rule may stipulate a correspondence between the number of ML processing resources and the structure of the ML model.

The other factors for determining the number of ML processing resources for one ML model include the algorithms of the ML model, the number of layers/neutrons/parameters/hyper-parameters of the ML model, and so on.

It should be appreciated that the above factors are given for the purpose of illustration without suggesting any limitations. The terminal device 220 may determine the respective number of ML processing resources for one ML model bases on any suitable factors. Further, the above factors and the other suitable factors may be used separately or in combination.

Additionally, in case that more than one factor is used for determining the number of ML processing resources for one ML model, different factors may be configured with different weights. In one specific example embodiment, the weights of the factors can be sorted by a certain order, for example, {latency, collaboration level, accuracy, . . . }. In this way, different factors may have different contribution when determining the number of ML processing resources for one ML model, and the rule may be defined more reasonable.

In one specific example embodiment, the respective number of ML processing resources for one ML model may be calculated by below equation (2).

$$NumRes ( ML model ) = M 1 * a + M 2 * b + M 3 * c + M 4 * d + M 5 * e \qquad ( 2 )$$

where, a=0 or 1, used for indicating real-time ML model and non-real-time ML model respectively;
b=0 or 1 or 2, used for indicating different collaboration levels, respectively;
c=0 or 1. used for indicating the ML type of the ML model, such as value 0 for two-sided ML model and value “1” for one-sided ML model;
d may be the model ID;
e may be the model group ID;
M1, M2, M3, M4 and M5 are coefficients separating the impacts of different factors. i.e., the weights.

It is to be understood that the above equation (2) is illustrated merely for the purpose of illustration without suggesting any limitations. In the other embodiments, the respective number of ML processing resources for one ML model may be calculated by any suitable equations. The present discourse is not limited in the regard.

In some embodiments, a first number of ML processing resources is determined for a first ML model for the terminal device 220, and a second number of ML processing resources is determined for the same first ML model operated at a further terminal device. In one example embodiment, the first number of ML processing resources is different from the second number of ML processing resources. In other words, different terminal devices may have different numbers of ML processing resources for the same ML model.

Alternatively, in another example embodiment, the first number of ML processing resources is the same with the second number of ML processing resources, while a first processing timing of the first number of ML processing resources is different from a second processing timing of the second number of ML processing resources.

Additionally, one example processing timing is the time duration that the number of ML processing resources are occupied. Another example processing timing is a time length used for one or more of the following: ML model training, ML model validation, ML model testing, and ML model inference. A further example processing timing is a time offset between the trigger/input data collected of ML model training/validation/testing/inference and respective output of ML model training/validation/testing/inference.

It is to be understood that the above examples of processing timing are only for the purpose of illustration without suggesting any limitations. In some other example embodiments, the processing timing may be any of other existing processing timings or newly defined processing timings in the future. The present discourse is not limited in this regard.

In some embodiments, the terminal device 220 suspends update procedure(s) for a subset of the at least one ML model. Additionally, the number of the subset of the at least one ML model is determined based on at least one of the following: a maximum number of ML processing resources supported by the terminal device, the number of the at least one ML model, or the respective number of ML processing resources occupied by each of the at least one ML model during a period.

In one specific example embodiment, if the maximum ML processing capability is N_{APU} APUs, and L AI processing units are occupied for ML processing in a given time unit (such as, a second, a millisecond, a frame, a slot, a OFDM symbol, and so on), the unoccupied APUs at the terminal device 220 may be calculated to be N_{APU}-L. If so, the terminal device 220 is not required to update the results of N-M ML models with lowest priority, where N is the number of active/running ML models, M is the largest value that

$${\sum }_{k = 0}^{M - 1} {O}_{A P U}^{k} <= {N}_{A P {U}^{-}} L holds , {O}_{A P U}^{k}$$

is the occupied APUs of the k-th ML model. That is, related one or more procedures (including but not limited to, ML model update, ML model training, ML model validation, ML model testing and ML model inference) of N-M ML modes are suspended.

It is to be understood that the above specific example for calculating the number of ML models to be suspended is only for the purpose of illustration without suggesting any limitations. In the other embodiments, other rules may be applied for calculating the number of ML models to be suspended. The present discourse is not limited at this regard.

### Processes for Adjusting Specification(s)

For better understanding, the example processes for adjusting specification(s) will be described with reference to FIG. 2A and FIG. 2B.

According to the below example processes, the device temperature or power consumption at the terminal device 220 may be controlled by adjusting the specification(s) (such as, a specification of a ML model and a specification of MIMO).

In some embodiment, the specification of the ML model is associated with an input size of the ML model. Alternatively, or in addition, in some embodiment, the specification of the ML model is associated with an output size of the ML model. Alternatively, or in addition, in some embodiment, the specification of the ML model is associated with a processing requirement of the ML model.

In some embodiment, the specification of MIMO is associated with a measurement specification of the MIMO. Alternatively, or in addition, in some embodiment, the specification of MIMO is associated with a computation specification of the MIMO. Alternatively, or in addition, in some embodiment, the specification of MIMO is associated with a maintenance specification of the MIMO.

In some embodiment, the terminal device 220 generates assistant information for adjusting the specification(s), and transmits 260 the assistant information to the network device 210.

As a general rule, in case of a high device temperature or power consumption, the terminal device 220 may reduce the related specification(s), while in case of a low/normal device temperature or power consumption, the terminal device 220 may increase the related specification(s).

Further, after adjusting the specification(s), in response to some pre-defined event (such as, expiration of a timer, or detecting disappearance of the high/low device temperature or power consumption), the terminal device 220 may fall back to a previous configuration/normal configuration.

In one specific example, the terminal device 220 generates the assistant information in response to defecting a temperature of the terminal device increasing to a first threshold temperature (such as, detecting internal overheating).

Alternatively, in another specific example, the terminal device 220 generates the assistant information in response to defecting a temperature of the terminal device decreasing to a second threshold temperature.

Alternatively, in another specific example, the terminal device 220 generates the assistant information in response to defecting a power consumption of the terminal device increasing to a first threshold consumption.

Alternatively, in another specific example, the terminal device 220 generates the assistant information in response to defecting a power consumption of the terminal device decreasing to a second threshold consumption.

In another specific example, the terminal device 220 starts a timer in response to applying the assistant information at the terminal device and falls back to a previous configuration in response to an expiration of the timer.

Additionally, additional signaling can be provided by the terminal device 220 in response to switching back to previous configuration/normal configuration.

In this way, the terminal device 220 may control its device temperature and power consumption at one acceptable range.

In some embodiment, the assistant information is suggestive information. In this event, the network device 210 may generate an adjust configuration for the terminal device 220 based on the assistant information. Next the network device 210 may transmit 270 the adjust configuration to the terminal device 220. In this way, in case that there is a need for adjusting specification(s), the terminal device 220 may inform the expected specification(s) to the network device 210, while the network device 210 also may control the final specification(s) to be adjusted for the termina device 220.

For better understanding, one example is described as below. If configured, the terminal device 220 capable of providing the assistance information may initiate the transmission of assistant information, upon a specific event (e.g., for overheating: detecting internal overheating, or upon detecting that it is no longer experiencing an overheating condition.) Further, upon initiating the procedure, the terminal device 220 shall:
1> if configured to provide the assistance information:
   2> if the event has been detected and a related timer is not running; or
   2> if the current assistance information is different from the one indicated in the last transmission of the assistance information, and the related timer is not running
      3> start the related timer with a specific value of time length;
      3> initiate transmission of the assistance information message to provide assistance information.

In some embodiment, the assistant information indicates an adjusted state which is currently valid at the terminal device 220. In this way, the adjustment at the terminal device 220 would be timely. For better understanding, one example is described as below. If configured, the terminal device 220 capable of providing the assistance information may initiate the transmission of assistant information, upon a specific event (e.g., for overheating: detecting internal overheating, or upon detecting that it is no longer experiencing an overheating condition.) Further, upon initiating the procedure, the terminal device 220 shall:
1> if configured to perform the related actions:
   2> if the event has been detected and a related timer is not running;
      3> start the related timer with a specific value of time length;
      3> perform the related actions;
      3> if configured to provide the assistance information, and the current assistance information is different from the one indicated in the last transmission of the assistance information, initiate transmission of the assistance information message to provide assistance information.

In some embodiments, the assistant information is associated with first information used for adjusting a specification of a ML model being operated at the terminal device 220.

In some embodiments, the first information indicates at least one the following:
a parameter used for stopping or enabling a training procedure of the ML model; such as, stopping or enabling data collection for AI/ML model training;
a parameter used for stopping or enabling an interference procedure of the ML model; such as, stopping or enabling data collection for AI/ML model interference;
a parameter used for stopping or enabling a downloading procedure of the ML model,
a parameter used for stopping or enabling an uploading procedure of the ML model,
a parameter used for switching the ML model to a lite ML model; the lite ML model may refer to a simpler ML model (which may be an ML model with less input/output/layers/neutrons/parameters/hyper-parameters).

In this way, the specification of processing requirement of the ML model is adjusted.

Alternatively, or in addition, the first information indicates a parameter used for relaxing or enhancing a processing timing requirement for the interference procedure. In one specific example embodiment, the terminal device 220 provides information to increase/decrease the inference timing, where the inference timing can be defined between the terminal device 220 collecting the measurement results as ML model input and the terminal device 220 obtaining the output. It is to be understood that the inference timing is one example of the processing timing. In the other embodiments, the processing timing may be defined to be training timing, validation timing and any suitable timing. The present discourse is not limited in this regard. In this way, the specification of ML model processing timing related may be adjusted.

Alternatively, or in addition, the first information indicates a parameter used for reducing or increasing the number of ML processing resources of the ML model, such as, reducing or increasing the computational size/resources of the ML model. More specifically, the terminal device 220 may reduce or increase the number of APUs of an AI/ML model; or the number of APUs of all AI/ML model. In this way, the specification of ML model computation resource related is adjusted.

Alternatively, or in addition, the first information indicates a parameter used for suspending or restoring a life-cycle management for the terminal device 220. In one example embodiment, the life-cycle management of the ML model may be temporarily stopped or enabled either by the terminal device 220 or the network device 210.

In one specific embodiment, the performance monitoring may be stopped or enabled, such as, stopping or starting the timer or counter configured for performance monitoring. In another specific embodiment, the monitoring periodicity may be shortened or enlarged. In a further specific embodiment, performance feedback may be stopped or enabled. In a further specific embodiment, the feedback periodicity may be shortened or enlarged. In a further specific embodiment, update/fine-tuning of ML model may be frozen/recovered.

Additionally, in some embodiments, the controlling/maintaining of ML model life-cycle management may also depend on the accuracy of AI/ML model.

In some embodiments, the first information indicates at least one the following:
a size of precoding matrix indicators (PMIs) for channel state information (CSI), as an input of the ML model,
a size of channel matrix for CSI, as an input of the ML model, or
the number of measurement instances for the CSI, as an input of the ML model; such as, the number of latest measurement instances used as input for CSI.

In this way, the specification(s) of the input size of the ML model for CSI (such as the size of input data) may be adjusted.

Alternatively, or in addition, in some embodiments, the first information indicates the number of measurement beams or measurement instances for a beam management, as an input of the ML model (such as, the number of latest measurement instances used as input for BM).

In this way, the specification(s) of the input size of the ML model for BM (such as the size of input data) may be adjusted.

In some embodiments, the first information indicates at least one the following:
the number of compressed bits for the CSI, as an output of the ML model,
the number of prediction instances for the CSI, as an output of the ML model; such as, number of F predictions for F future time instances.

In this way, the specification(s) of the output size of the ML model for CSI (such as the size of output data) may be adjusted.

Alternatively, or in addition, in some embodiments, the first information indicates the number of predicted beams or predicted instances for the beam management, as an output of the ML model (such as, number of F predictions for F future time instances). In this way, the specification(s) of the output size of the ML model for BM (such as the size of output data) may be adjusted.

In this way, the specification(s) of either an input size of the ML model or an output size of the ML model is adjusted.

Alternatively, in some embodiments, the assistant information is associated with second information used for adjusting a specification of a MIMO. In particular, the second information is associated with at least one of the following: a measurement specification of the MIMO, a computation specification of the MIMO, or a maintenance specification of the MIMO.

In some embodiments, the second information indicates at least one the following:
the number of reference signal (RS) to be measured,
the number of RSs to be reported,
a transmission periodicity of RS,
a report periodicity of RS,
the number of receiver beams to be measured, either across all BWP/CCs or per BWP/CC,
the number of transmit beams to be measured, either across all BWP/CCs or per BWP/CC,
the number of transmit-receiver beam pairs to be measured, either across all BWP/CCs or per BWP/CC, or
the number of ports of RS.

In this way, the specification(s) of measurement related may be adjusted.

In some embodiments, the second information indicates at least one the following:
a processing time for physical downlink shared channel (PDSCH),
a preparation time for physical uplink shared channel (PUSCH),
a time offset between any two of a trigger of reference signal (RS), a transmission of RS, and a report of RS,
a beam application timing,
a beam switching timing,
a time duration for quasi co-location (QCL),
a computation time of channel state information (CSI), or
the number of machine learning (ML) processing resources for CSI.

In this way, the specification(s) of computation related may be adjusted.

In some embodiments, the second information indicates at least one the following:
the number of activated transmission configuration indicator (TCI) states,
the number of beams to be maintained,
the number of path loss (PL) reference signal (RS) to be maintained, or
a depth of QCL chain.

In this way, the specification(s) of maintenances related may be adjusted.

In some embodiments, the second information indicates at least one the following:
an UL power,
a maximum power exposure MPE,
maximum output power reduction (MPR),
a power management maximum power reduction (P-MPR),
additional maximum power reduction (A-MPR),
a duty cycle for uplink transmission,
the number of sounding reference signal (SRS) resource sets,
The number of panels used for uplink transmission,
The number of panels used for uplink transmission simultaneously;
an indication indicating a switch from supporting STxMP to not support STxMP,
the number of panels used for uplink transmission,
Maximum supported modulation and coding scheme (MCS),
a transport block size (TBS),
Quality of Service (QoS),
Quality of Experience (QoE),
a switching BWP indication: for example, switching back to initial BWP or to a BWP with smallest bandwidth.

### Processes for Predicting and Adjusting

For better understanding, the example processes for adjusting specification(s) will be described with reference to FIG. 2A and FIG. 2B.

According to the below example processes, the terminal device 220 may predict a temperature change in a subsequent period and relieve the temperature change by using assistant information. Thus, the high data rate and the device temperature may be well balanced.

For example, if the terminal device 220 predicts that the temperature at the terminal device 220 may be high, the terminal device 220 adopts adaptive configurations of at least data transmissions, MIMO processing, and AI/ML processing based on predicted event. Alternatively, the terminal device 220 also may reduce other functionalities to avoid temperature rise based on the predicted result.

In some embodiments, the terminal device 220 predicts a temperature change in a subsequent period. In case that the temperature change meets a adjust condition, the terminal device 220 determines assistant information (such as, according to the example processes for adjusting specification(s) discussed in this discourse) and transmits 260 the assistant information to a network device 210.

In some embodiments, the assistant information is associated with at least one of the following:
first information used for adjusting a specification of a ML model being operated at the terminal devoice, or
second information used for adjusting a specification of a multiple input multiple output (MIMO).

In this way, the related specification(s) may be adjusted, such that the temperature change may be relieved.

Alternatively, in some embodiments, the assistant information is associated with at least one of the following:
a cause associated with the temperature change, such as, an online game prefers to require low-latency, an online video prefer to require a high-data rate requirement,
an amount of data to be transmitted,
at least one transmission performance requirement in the subsequent period, or
third information for adjusting a performance for data transmission in the subsequent period, such as, the amount of predicted data to be transmitted, the required data rate, QoS or QoE, latency, and the lasting time of the high data rate transmission.

In this way, the network device 210 may well understand the current state of the termina device 220.

In some embodiments, the terminal device 220 obtains the assistant information from a pre-defined configuration, the pre-defined configuration indicating a correspondence between a temperature change and at least one parameter set. With the pre-defined configuration, an adaptive transmission/measurement/computation may be achieved based on different (predicted) temperatures. Further, by using the pre-defined configuration, no explicit signaling on MIMO configurations and AI/ML processing are needed to be provided to the network device 210.

Below table 2 illustrates an example of pre-defined configuration.

TABLE 2
example of pre-defined configuration

| | data rate/QoS/ | | |
|---|---|---|---|
| | QoE/latency | MIMO | AI/ML |
| assistant | (predicted/ | configuration | processing |
| information | required) | (adaptive) | (adaptive) |
| First temperature | First | First | First |
| (predicted/measured) | value/range | configuration | processing |
| First cause of | | | capacities |
| overheating | | | |
| Second temperature | Second | Second | Second |
| (predicted/measured) | value/range | configuration | processing |
| Second cause of | | | capabilities |
| overheating | | | |

It is to be understood that the above table 2 is only for the purpose of illustration without suggesting any limitations. The contents in the above table 2, and the numbers of the rows and columns may be changed in the other embodiments.

Alternately, the assistant information is determined by using a ML model (such as, AI/ML model for task scheduler). That is, the predicted/measured temperature (and cause associated with the temperature change) may be used as the inputs of the ML model, and the assistant information is outputted by the ML model.

Additionally, as discussed above, the device temperature is influenced by a plurality of factors, include but are not limited to, environmental factors, communication-related factors, non-communication-related factors, AI/ML-related factors. Thus, the input also may comprise one or more of the following: temperature range, UE position, time, current application status, buffer size, battery status, data rate, application data rate requirement, service type, and so on. Furter, the above input is obtained during a historical time, such as, a past time duration.

In some embodiments, the assistant information indicates the reasonable combinations of transmission/MIMOI/AI configurations for a future time, such as, a future duration.

Additionally, in case that the assistant information is determined by using a ML model, the terminal device 220 also may label the assistant information with AI/ML prediction indication, such that the network device 210 may understand that the assistant information is determined by a ML model.

Similarly with the example processes for adjusting specification(s), the assistant information generated in response to the temperature change also may either be suggestive information or indicate an adjusted state which is currently valid at the terminal device 220.

Merely for brevity, similar contents are omitted here.

### Example Methods

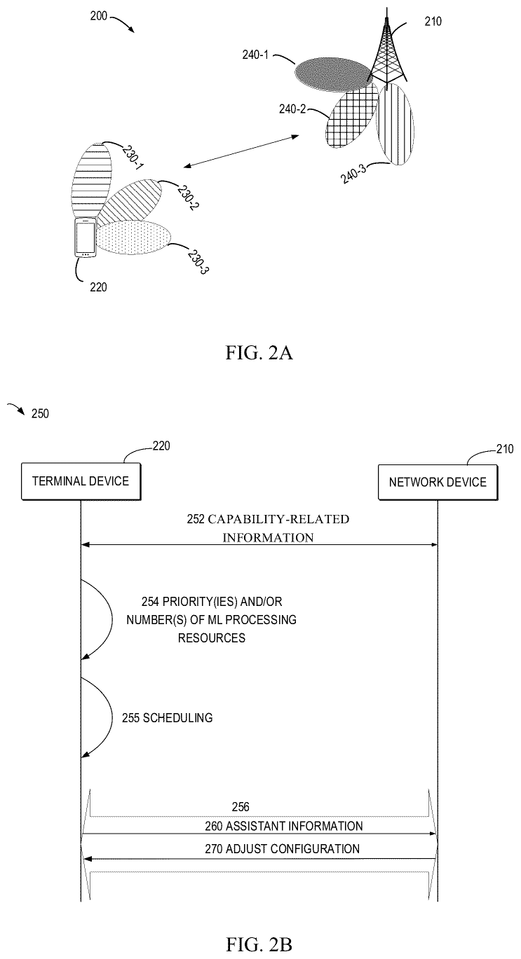

FIG. 3 illustrates a flowchart of an example method 300 in accordance with some embodiments of the present disclosure. For example, the method 300 can be implemented at the terminal device 220 as shown in FIG. 2A.

At block 310, the terminal device 220 determines the respective number of ML processing resources or a respective priority for each ML model of at least one ML model being operated at the terminal device 220 based on at least one factor including the following: a real-time requirement of the ML model, a latency of the ML model, a collaboration level of the ML model, a report transmission requirement of the ML model, a ML type of the ML model, the ML type being one of a two-sided ML model or a one-sided ML model, the number of entities involved in the ML model, a functionality of the ML model, a ML group which the ML model belongs to, an accuracy requirement of the ML model, or a communication protocol layer associated with the ML model.

At block 320, the terminal device 220 schedules, based on the respective numbers of ML processing resources or the respective priorities, ML processing resources for the at least one ML model.

In some embodiments, different factors of the at least one factor are configured with different weights.

In some embodiments, the terminal device 220 determines the respective number of ML processing resources or the respective priority comprises: determining the respective number of ML processing resources or the respective priority according to at least one rule, the at least one rule defining: a first priority of a first ML model is higher than a second priority of a second ML model or a first number of ML processing resources for the first ML model is larger than a second ML processing resources for the second ML model if at least one of: the first ML model is a real-time ML model and the second ML model is a non-real-time ML model, the first ML model requires a lower latency compared with the second ML model, the first ML model requires a higher collaboration level compared with the second ML model, the first ML model requires a higher accuracy compared with the second ML model, an ML type of the ML model of the first ML model is two-sided ML model, and an ML type of the ML model of the second ML model is one-sided ML model, the number of entities involved in the first ML model is larger than the number of entities involved in the second ML model, the first ML model requires a report transmission, and the second ML model does not require a report transmission, the first ML model requires a higher accuracy compared with the second ML model, a communication protocol layer associated with the first ML model is lower than a second communication protocol layer associated with the second ML model, or the first ML model is a communication-related ML model and the second ML model is a communication-irrelevant ML model.

In some embodiments, the at least one rule is pre-defined, or dynamically or semi-statically configured.

In some embodiments, the at least one rule is common with regards to the terminal device 220 and at least one further terminal device 220, or the at least one rule is specific to the terminal device 220.

In some embodiments, the terminal device 220 suspends an update procedure for a subset of the at least one ML model according to the respective priorities.

In some embodiments, the number of the subset of the at least one ML model is determined based on at least one of the following: a maximum number of ML processing resources supported by the terminal device 220, the number of the at least one ML model, or the respective number of ML processing resources occupied by each of the at least one ML model during a period.

In some embodiments, when determining the respective number of ML processing resources for each ML model of at least one ML model, the at least one factor further comprises: an input size of the ML model, an output size of the ML model, a structure of the ML model, or a stage of life-cycle management at which the ML model is currently operated.

In some embodiments, the stage of life-cycle management may be one of the following: ML model deployment, performance monitoring, feedback, update and other stages of life-cycle management.

In some embodiments, when determining the respective number of ML processing resources for each ML model of at least one ML model, the at least one factor further comprises: a phase of ML model being one of the following: a training phase, a validation phase, a testing phase, or an inference phase.

In some embodiments, the phase of life-cycle management is one of the following: a training phase, a validation phase, a testing phase, or an inference phase.

In some embodiments, a first number of ML processing resources is determined for a first ML model of at least one ML model, and a second number of ML processing resources is determined for the same first ML model operated at a further terminal device 220, and wherein the first number of ML processing resources is different from or the same with the second number of ML processing resources.

In some embodiments, if the first number of ML processing resources is the same with the second number of ML processing resources, a first processing timing of the first number of ML processing resources is different from a second processing timing of the second number of ML processing resources.

In some embodiments, the terminal device 220 transmits, to a network device 210, a maximum ML processing capability supported by the terminal device 220.

In some embodiments, the ML processing resources comprise: a plurality of APUs.

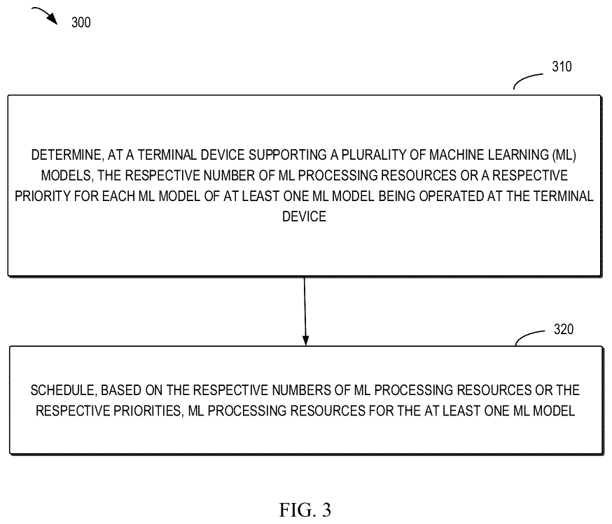

FIG. 4 illustrates a flowchart of an example method 400 in accordance with some embodiments of the present disclosure. For example, the method 400 can be implemented at the terminal device 220 as shown in FIG. 2A.

At block 410, the terminal device 220 generates assistant information associated with at least one of the following: first information used for adjusting a specification of a ML model being operated at the terminal device 220, or second information used for adjusting a specification of a MIMO, the second information associated with at least one of the following: a measurement specification of the MIMO, a computation specification of the MIMO, or a maintenance specification of the MIMO.

At block 420, the terminal device 220 transmits, the assistant information to the network device 210.

In some embodiments, the assistant information is suggestive information, the method further comprises: receiving, from the network device 210, an adjust configuration to be used by the terminal device 220.

In some embodiments, the assistant information indicates an adjusted state which is currently valid at the terminal device 220.

In some embodiments, the terminal device 220 generates the assistant information in response to defecting at least one of the following: a temperature of the terminal device 220 increasing to a first threshold temperature, a temperature of the terminal device 220 decreasing to a second threshold temperature, a power consumption of the terminal device 220 increasing to a first threshold consumption, or a power consumption of the terminal device 220 decreasing to a second threshold consumption.

In some embodiments, the terminal device 220 starts a timer in response to applying the assistant information at the terminal device 220, and falls back to a previous configuration in response to an expiration of the timer.

In some embodiments, the specification of the ML model is associated with at least one of the following: an input size of the ML model, an output size of the ML model, or a processing requirement of the ML model.

In some embodiments, the first information indicates at least one the following: a parameter used for stopping or enabling a training procedure of the ML model, a parameter used for stopping or enabling an interference procedure of the ML model, a parameter used for stopping or enabling a downloading procedure of the ML model, a parameter used for stopping or enabling an uploading procedure of the ML model, a parameter used for relaxing or enhancing a processing timing requirement for the interference procedure, a parameter used for reducing or increasing the number of ML processing resources of the ML model, a parameter used for switching the ML model to a lite ML model, or a parameter used for suspending or restoring a life-cycle management for the terminal device 220.

In some embodiments, the first information associated with at least one the following: a size of PMIs for CSI, as an input of the ML model, a size of channel matrix for CSI, as an input of the ML model, the number of measurement instances for the CSI, as an input of the ML model, the number of compressed bits for the CSI, as an output of the ML model, the number of prediction instances for the CSI, as an output of the ML model, the number of measurement beams or measurement instances for a beam management, as an input of the ML model, or the number of predicted beams or predicted instances for the beam management, as an output of the ML model.

In some embodiments, the second information indicates at least one the following: the number of RSs to be measured, the numbers of RS to be reported, a transmission periodicity of RS, a report periodicity of RS, the number of receiver beams to be measured, the number of transmit beams to be measured, the number of transmit-receiver beam pairs to be measured, or the number of ports of RS.

In some embodiments, the second information indicates at least one the following: a processing time for PDSCH, a preparation time for PUSCH, a time offset between any two of a trigger of RS, a transmission of RS, and a report of RS, a beam application timing, a beam switching timing, a time duration for QCL, a computation time of CSI, the number of ML processing resources for CSI, the number of activated TCI states, the number of beams to be maintained, the number of PL RS to be maintained, a depth of QCL chain.

In some embodiments, the second information indicates at least one the following: a duty cycle for uplink transmission, the number of SRS resource sets, the number of panels used for uplink transmission.

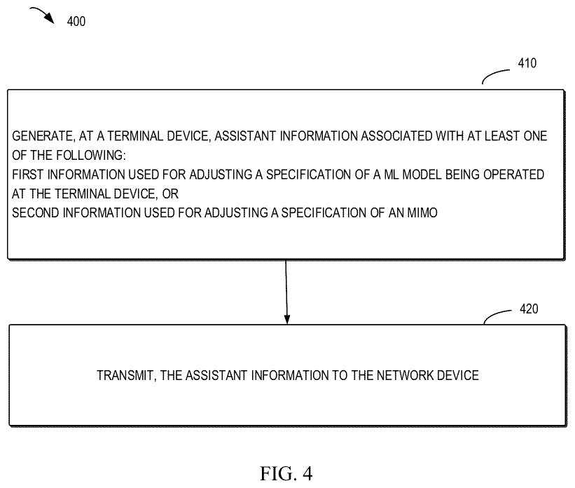

FIG. 5 illustrates a flowchart of an example method 500 in accordance with some embodiments of the present disclosure. For example, the method 500 can be implemented at the terminal device 220 as shown in FIG. 2A.

At block 510, the terminal device 220 determines, a temperature change in a subsequent period; determining assistant information if the temperature change meets a adjust condition, the assistant information used for relieving the temperature change in the subsequent period.

At block 520, the terminal device 220 transmits the assistant information to a network device 210.

In some embodiments, the assistant information is associated with at least one of the following: the temperature change, a cause associated with the temperature change, an amount of data to be transmitted, at least one transmission performance requirement in the subsequent period, first information used for adjusting a specification of a ML model being operated at the terminal devoice, second information used for adjusting a specification of a MIMO, or third information for adjusting a performance for data transmission in the subsequent period.

In some embodiments, the terminal device 220 obtains the assistant information from a pre-defined configuration, the pre-defined configuration indicating a correspondence between a temperature change and at least one parameter set.

In some embodiments, the terminal device 220 determines the assistant information by using a ML model.

In some embodiments, the assistant information is suggestive information, the terminal device 220 receives, from the network device 210, an adjust configuration to be used by the terminal device 220.

In some embodiments, the assistant information indicating an adjusted state which is currently valid at the terminal device 220.

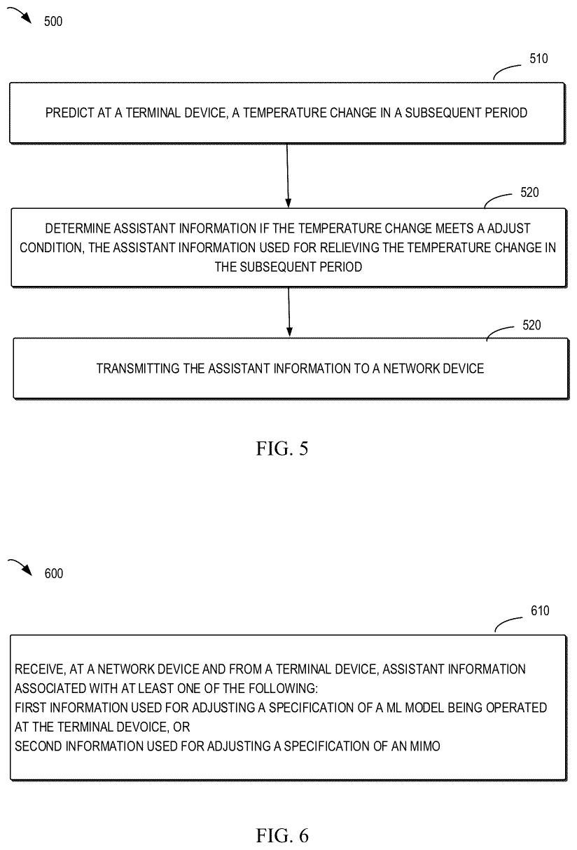

FIG. 6 illustrates a flowchart of an example method 600 in accordance with some embodiments of the present disclosure. For example, the method 600 can be implemented at the network device 210 as shown in FIG. 2A.

At block 610, the network device 210 receives from a terminal device 220, assistant information associated with at least one of the following: first information used for adjusting a specification of a ML model being operated at the terminal devoice, or second information used for adjusting a specification of a MIMO.

In some embodiments, the assistant information is suggestive information, the method further comprises: generating, based on the assistant information, an adjust configuration to be used by the terminal device 220; and transmitting the adjust configuration to the terminal device 220.

In some embodiments, the assistant information indicating an adjusted state which is currently valid at the terminal device 220.

In some embodiments, the specification of the ML model is associated with at least one of the following: an input size of the ML model, an output size of the ML model, or a processing requirement of the ML model.

In some embodiments, the first information indicates at least one the following: a parameter used for stopping or enabling a training procedure of the ML model, a parameter used for stopping or enabling an interference procedure of the ML model, a parameter used for stopping or enabling a downloading procedure of the ML model, a parameter used for stopping or enabling an uploading procedure of the ML model, a parameter used for relaxing or enhancing a processing timing requirement for the interference procedure, a parameter used for reducing or increasing the number of ML processing resources of the ML model, a parameter used for switching the ML model to a lite ML model, or a parameter used for suspending or restoring a life-cycle management for the terminal device 220.

In some embodiments, the first information associated with at least one the following: a size of PMIs for CSI, as an input of the ML model, a size of channel matrix for CSI, as an input of the ML model, the number of measurement instances for the CSI, as an input of the ML model, the number of compressed bits for the CSI, as an output of the ML model, the number of prediction instances for the CSI, as an output of the ML model, the number of measurement beams or measurement instances for a beam management, as an input of the ML model, or the number of predicted beams or predicted instances for the beam management, as an output of the ML model.

In some embodiments, the specification of the MIMO is associated with at least one of the following: a measurement specification of the MIMO, a computation specification of the MIMO, or a maintenance specification of the MIMO.

In some embodiments, the second information indicates at least one the following: the number of RSs to be measured, the number of RSs to be reported, a transmission periodicity of RS, a report periodicity of RS, the number of receiver beams to be measured, the number of transmit beams to be measured, the number of transmit-receiver beam pairs to be measured, the number of ports of RS.

In some embodiments, the second information indicates at least one the following: a processing time for PDSCH, a preparation time for PUSCH, a time offset between any two of a trigger of RS, a transmission of RS, and a report of RS, a beam application timing, a beam switching timing, a time duration for QCL, a computation time of CSI, the number of ML processing resources for CSI, the number of activated TCI states, the number of beams to be maintained, the number of PL RS to be maintained, a depth of QCL chain.

In some embodiments, the second information indicates at least one the following: a duty cycle for uplink transmission, the number of SRS resource sets, the number of panels used for uplink transmission.

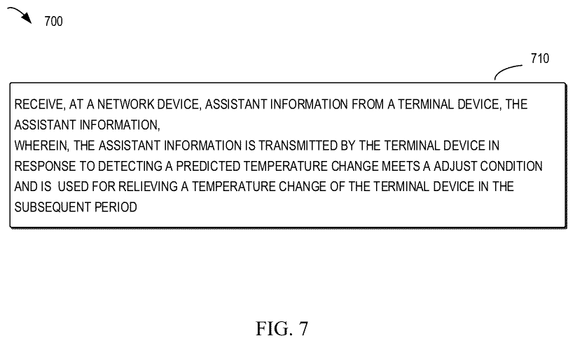

FIG. 7 illustrates a flowchart of an example method 700 in accordance with some embodiments of the present disclosure. For example, the method 700 can be implemented at the network device 210 as shown in FIG. 2A.

At block 710, the network device 210 receives assistant information from a terminal device 220, the assistant information, wherein, the assistant information is transmitted by the terminal device 220 in response to detecting a predicted temperature change meets a adjust condition and is used for relieving a temperature change of the terminal device 220 in the subsequent period.

In some embodiments, the assistant information is associated with at least one of the following: the temperature change, a cause associated with the temperature change, an amount of data to be transmitted, at least one transmission performance requirement in the subsequent period, first information used for adjusting a specification of a ML model being operated at the terminal devoice, second information used for adjusting a specification of a MIMO, or third information for adjusting a performance for data transmission in the subsequent period.

In some embodiments, the assistant information is suggestive information, the network device 210 generates, based on the assistant information, an adjust configuration to be used by the terminal device 220; and transmitting the adjust configuration to the terminal device 220.

In some embodiments, the assistant information indicating an adjusted state which is currently valid at the terminal device 220.

### Example Devices

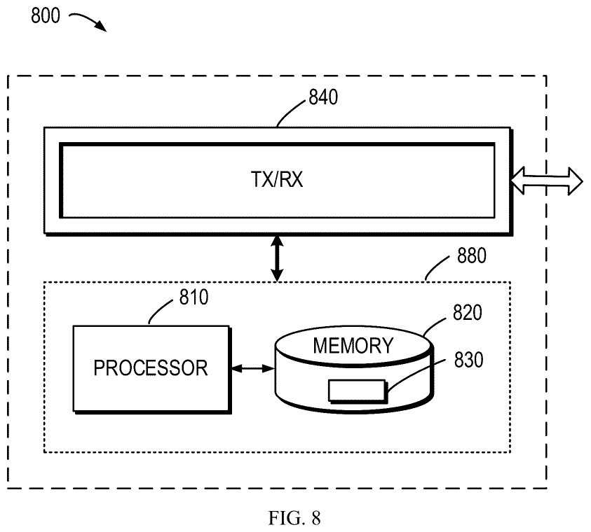

FIG. 8 is a simplified block diagram of a device 800 that is suitable for implementing embodiments of the present disclosure. The device 800 can be considered as a further example implementation of the terminal device 220 or the network device 210 as shown in FIG. 2A. Accordingly, the device 800 can be implemented at or as at least a part of the terminal device 220 or the network device 210.

As shown, the device 800 includes a processor 810, a memory 820 coupled to the processor 810, a suitable transmitter (TX)/receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between cNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 2A to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 880 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises a circuitry configured to: determine the respective number of ML processing resources or a respective priority for each ML model of at least one ML model being operated at the terminal device 220 based on at least one factor including the following: a real-time requirement of the ML model, a latency of the ML model, a collaboration level of the ML model, a report transmission requirement of the ML model, a ML type of the ML model, the ML type being one of a two-sided ML model or a one-sided ML model, the number of entities involved in the ML model, a functionality of the ML model, a ML group which the ML model belongs to, an accuracy requirement of the ML model, or a communication protocol layer associated with the ML model; and schedule, based on the respective numbers of ML processing resources or the respective priorities, ML processing resources for the at least one ML model.

In some embodiments, different factors of the at least one factor are configured with different weights.

In some embodiments, the circuitry is further configured to: determine the respective number of ML processing resources or the respective priority comprises: determining the respective number of ML processing resources or the respective priority according to at least one rule, the at least one rule defining: a first priority of a first ML model is higher than a second priority of a second ML model or a first number of ML processing resources for the first ML model is larger than a second ML processing resources for the second ML model if at least one of: the first ML model is a real-time ML model and the second ML model is a non-real-time ML model, the first ML model requires a lower latency compared with the second ML model, the first ML model requires a higher collaboration level compared with the second ML model, the first ML model requires a higher accuracy compared with the second ML model, an ML type of the ML model of the first ML model is two-sided ML model, and an ML type of the ML model of the second ML model is one-sided ML model, the number of entities involved in the first ML model is larger than the number of entities involved in the second ML model, the first ML model requires a report transmission, and the second ML model does not require a report transmission, the first ML model requires a higher accuracy compared with the second ML model, a communication protocol layer associated with the first ML model is lower than a second communication protocol layer associated with the second ML model, or the first ML model is a communication-related ML model and the second ML model is a communication-irrelevant ML model.

In some embodiments, the at least one rule is pre-defined, or dynamically or semi-statically configured.

In some embodiments, the at least one rule is common with regards to the terminal device 220 and at least one further terminal device 220, or the at least one rule is specific to the terminal device 220.

In some embodiments, the circuitry is further configured to: suspend an update procedure for a subset of the at least one ML model according to the respective priorities.

In some embodiments, the number of the subset of the at least one ML model is determined based on at least one of the following: a maximum number of ML processing resources supported by the terminal device 220, the number of the at least one ML model, or the respective number of ML processing resources occupied by each of the at least one ML model during a period.

In some embodiments, when determining the respective number of ML processing resources for each ML model of at least one ML model, the at least one factor further comprises: an input size of the ML model, an output size of the ML model, a structure of the ML model, or a stage of life-cycle management at which the ML model is currently operated.

In some embodiments, the stage of life-cycle management may be one of the following: ML model deployment, performance monitoring, feedback, update and other stages of life-cycle management.

In some embodiments, when determining the respective number of ML processing resources for each ML model of at least one ML model, the at least one factor further comprises: a phase of ML model being one of the following: a training phase, a validation phase, a testing phase, or an inference phase.

In some embodiments, a first number of ML processing resources is determined for a first ML model of at least one ML model, and a second number of ML processing resources is determined for the same first ML model operated at a further terminal device 220, and wherein the first number of ML processing resources is different from or the same with the second number of ML processing resources.

In some embodiments, if the first number of ML processing resources is the same with the second number of ML processing resources, a first processing timing of the first number of ML processing resources is different from a second processing timing of the second number of ML processing resources.

In some embodiments, the circuitry is further configured to: transmit, to a network device 210, a maximum ML processing capability supported by the terminal device 220.

In some embodiments, the ML processing resources comprise: a plurality of APUs.

In some embodiments, a terminal device comprises a circuitry configured to: generate assistant information associated with at least one of the following: first information used for adjusting a specification of a ML model being operated at the terminal device 220, or second information used for adjusting a specification of a MIMO, the second information associated with at least one of the following: a measurement specification of the MIMO, a computation specification of the MIMO, or a maintenance specification of the MIMO; and transmit, the assistant information to the network device 210.

In some embodiments, the assistant information is suggestive information, the method further comprises: receiving, from the network device 210, an adjust configuration to be used by the terminal device 220.

In some embodiments, the assistant information indicates an adjusted state which is currently valid at the terminal device 220.

In some embodiments, the circuitry is further configured to: generate the assistant information in response to defecting at least one of the following: a temperature of the terminal device 220 increasing to a first threshold temperature, a temperature of the terminal device 220 decreasing to a second threshold temperature, a power consumption of the terminal device 220 increasing to a first threshold consumption, or a power consumption of the terminal device 220 decreasing to a second threshold consumption.

In some embodiments, the circuitry is further configured to: start a timer in response to applying the assistant information at the terminal device 220, and fall back to a previous configuration in response to an expiration of the timer.

In some embodiments, the specification of the ML model is associated with at least one of the following: an input size of the ML model, an output size of the ML model, or a processing requirement of the ML model.

In some embodiments, the first information indicates at least one the following: a parameter used for stopping or enabling a training procedure of the ML model, a parameter used for stopping or enabling an interference procedure of the ML model, a parameter used for stopping or enabling a downloading procedure of the ML model, a parameter used for stopping or enabling an uploading procedure of the ML model, a parameter used for relaxing or enhancing a processing timing requirement for the interference procedure, a parameter used for reducing or increasing the number of ML processing resources of the ML model, a parameter used for switching the ML model to a lite ML model, or a parameter used for suspending or restoring a life-cycle management for the terminal device 220.

In some embodiments, the first information associated with at least one the following: a size of PMIs for CSI, as an input of the ML model, a size of channel matrix for CSI, as an input of the ML model, the number of measurement instances for the CSI, as an input of the ML model, the number of compressed bits for the CSI, as an output of the ML model, the number of prediction instances for the CSI, as an output of the ML model, the number of measurement beams or measurement instances for a beam management, as an input of the ML model, or the number of predicted beams or predicted instances for the beam management, as an output of the ML model.

In some embodiments, the second information indicates at least one the following: the number of RSs to be measured, the number of RSs to be reported, a transmission periodicity of RS, a report periodicity of RS, the number of receiver beams to be measured, the number of transmit beams to be measured, the number of transmit-receiver beam pairs to be measured, or the number of ports of RS.

In some embodiments, the second information indicates at least one the following: a processing time for PDSCH, a preparation time for PUSCH, a time offset between any two of a trigger of RS, a transmission of RS, and a report of RS, a beam application timing, a beam switching timing, a time duration for QCL, a computation time of CSI, the number of ML processing resources for CSI, the number of activated TCI states, the number of beams to be maintained, the number of PL RS to be maintained, a depth of QCL chain.

In some embodiments, the second information indicates at least one the following: a duty cycle for uplink transmission, the number of SRS resource sets, the number of panels used for uplink transmission.

In some embodiments, a terminal device comprises a circuitry configured to: determine, a temperature change in a subsequent period; determining assistant information if the temperature change meets a adjust condition, the assistant information used for relieving the temperature change in the subsequent period; and transmit the assistant information to a network device 210.

In some embodiments, the assistant information is associated with at least one of the following: the temperature change, a cause associated with the temperature change, an amount of data to be transmitted, at least one transmission performance requirement in the subsequent period, first information used for adjusting a specification of a ML model being operated at the terminal devoice, second information used for adjusting a specification of a MIMO, or third information for adjusting a performance for data transmission in the subsequent period.

In some embodiments, the circuitry is further configured to: obtain the assistant information from a pre-defined configuration, the pre-defined configuration indicating a correspondence between a temperature change and at least one parameter set.

In some embodiments, the circuitry is further configured to: determine the assistant information by using a ML model,

In some embodiments, the assistant information is suggestive information, the circuitry is further configured to: receive, from the network device 210, an adjust configuration to be used by the terminal device 220.

In some embodiments, the assistant information indicating an adjusted state which is currently valid at the terminal device 220.

In some embodiments, a network device comprises a circuitry configured to: receive from a terminal device 220, assistant information associated with at least one of the following: first information used for adjusting a specification of a ML model being operated at the terminal devoice, or second information used for adjusting a specification of a MIMO.

In some embodiments, the assistant information is suggestive information, the method further comprises: generating, based on the assistant information, an adjust configuration to be used by the terminal device 220; and transmitting the adjust configuration to the terminal device 220.

In some embodiments, the assistant information indicating an adjusted state which is currently valid at the terminal device 220.

In some embodiments, the specification of the ML model is associated with at least one of the following: an input size of the ML model, an output size of the ML model, or a processing requirement of the ML model.

In some embodiments, the first information indicates at least one the following: a parameter used for stopping or enabling a training procedure of the ML model, a parameter used for stopping or enabling an interference procedure of the ML model, a parameter used for stopping or enabling a downloading procedure of the ML model, a parameter used for stopping or enabling an uploading procedure of the ML model, a parameter used for relaxing or enhancing a processing timing requirement for the interference procedure, a parameter used for reducing or increasing the number of ML processing resources of the ML model, a parameter used for switching the ML model to a lite ML model, or a parameter used for suspending or restoring a life-cycle management for the terminal device 220.

In some embodiments, the first information associated with at least one the following: a size of PMIs for CSI, as an input of the ML model, a size of channel matrix for CSI, as an input of the ML model, the number of measurement instances for the CSI, as an input of the ML model, the number of compressed bits for the CSI, as an output of the ML model, the number of prediction instances for the CSI, as an output of the ML model, the number of measurement beams or measurement instances for a beam management, as an input of the ML model, or the number of predicted beams or predicted instances for the beam management, as an output of the ML model.

In some embodiments, the specification of the MIMO is associated with at least one of the following: a measurement specification of the MIMO, a computation specification of the MIMO, or a maintenance specification of the MIMO.

In some embodiments, the second information indicates at least one the following: the number of RSs to be measured, the number of RSs to be reported, a transmission periodicity of RS, a report periodicity of RS, the number of receiver beams to be measured, the number of transmit beams to be measured, the number of transmit-receiver beam pairs to be measured, the number of ports of RS.

In some embodiments, the second information indicates at least one the following: a processing time for PDSCH, a preparation time for PUSCH, a time offset between any two of a trigger of RS, a transmission of RS, and a report of RS, a beam application timing, a beam switching timing, a time duration for QCL, a computation time of CSI, the number of ML processing resources for CSI, the number of activated TCI states, the number of beams to be maintained, the number of PL RS to be maintained, a depth of QCL chain.

In some embodiments, the second information indicates at least one the following: a duty cycle for uplink transmission, the number of SRS resource sets, the number of panels used for uplink transmission.

In some embodiments, a network device comprises a circuitry configured to: receive assistant information from a terminal device 220, the assistant information, wherein, the assistant information is transmitted by the terminal device 220 in response to detecting a predicted temperature change meets a adjust condition and is used for relieving a temperature change of the terminal device 220 in the subsequent period.

In some embodiments, the assistant information is associated with at least one of the following: the temperature change, a cause associated with the temperature change, an amount of data to be transmitted, at least one transmission performance requirement in the subsequent period, first information used for adjusting a specification of a ML model being operated at the terminal devoice, second information used for adjusting a specification of a MIMO, or third information for adjusting a performance for data transmission in the subsequent period.

In some embodiments, the assistant information is suggestive information, the circuitry is further configured to: generate, based on the assistant information, an adjust configuration to be used by the terminal device 220; and transmitting the adjust configuration to the terminal device 220.

In some embodiments, the assistant information indicating an adjusted state which is currently valid at the terminal device 220. The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication, comprising: determining, at a terminal device supporting a plurality of machine learning (ML) models, the respective number of ML processing resources or a respective priority for each ML model of at least one ML model being operated at the terminal device based on at least one factor including the following: a real-time requirement of the ML model, a latency of the ML model, a collaboration level of the ML model, a report transmission requirement of the ML model, a ML type of the ML model, the ML type being one of a two-sided ML model or a one-sided ML model, the number of entities involved in the ML model, a functionality of the ML model, a ML group which the ML model belongs to, an accuracy requirement of the ML model, or a communication protocol layer associated with the ML model; and scheduling, based on the respective numbers of ML processing resources or the respective priorities, ML processing resources for the at least one ML model.

In some embodiments, different factors of the at least one factor are configured with different weights.

In some embodiments, determining the respective number of ML processing resources or the respective priority comprises: determining the respective number of ML processing resources or the respective priority according to at least one rule, the at least one rule defining: a first priority of a first ML model is higher than a second priority of a second ML model or a first number of ML processing resources for the first ML model is larger than a second ML processing resources for the second ML model if at least one of: the first ML model is a real-time ML model and the second ML model is a non-real-time ML model, the first ML model requires a lower latency compared with the second ML model, the first ML model requires a higher collaboration level compared with the second ML model, the first ML model requires a higher accuracy compared with the second ML model, an ML type of the ML model of the first ML model is two-sided ML model, and an ML type of the ML model of the second ML model is one-sided ML model, the number of entities involved in the first ML model is larger than the number of entities involved in the second ML model, the first ML model requires a report transmission, and the second ML model does not require a report transmission, the first ML model requires a higher accuracy compared with the second ML model, a communication protocol layer associated with the first ML model is lower than a second communication protocol layer associated with the second ML model, or the first ML model is a communication-related ML model and the second ML model is a communication-irrelevant ML model.

In some embodiments, the at least one rule is pre-defined, or dynamically or semi-statically configured.

In some embodiments, the at least one rule is common with regards to the terminal device and at least one further terminal device, or the at least one rule is specific to the terminal device.

In some embodiments, the method further comprises: suspending an update procedure for a subset of the at least one ML model according to the respective priorities.

In some embodiments, the number of the subset of the at least one ML model is determined based on at least one of the following: a maximum number of ML processing resources supported by the terminal device, the number of the at least one ML model, or the respective number of ML processing resources occupied by each of the at least one ML model during a period.

In some embodiments, determining the respective number of ML processing resources for each ML model of at least one ML model, the at least one factor further comprises: an input size of the ML model, an output size of the ML model, a structure of the ML model, or a stage of life-cycle management at which the ML model is currently operated.

In some embodiments, the stage of life-cycle management may be one of the following: ML model deployment, performance monitoring, feedback, update and other stages of life-cycle management.

In some embodiments, when determining the respective number of ML processing resources for each ML model of at least one ML model, the at least one factor further comprises: a phase of ML model being one of the following: a training phase, a validation phase, a testing phase, or an inference phase.

In some embodiments, a first number of ML processing resources is determined for a first ML model of at least one ML model, and a second number of ML processing resources is determined for the same first ML model operated at a further terminal device, and wherein the first number of ML processing resources is different from or the same with the second number of ML processing resources.

In some embodiments, if the first number of ML processing resources is the same with the second number of ML processing resources, a first processing timing of the first number of ML processing resources is different from a second processing timing of the second number of ML processing resources.

In some embodiments, the method further comprises: transmitting, to a network device, a maximum ML processing capability supported by the terminal device.

In some embodiments, the ML processing resources comprise: a plurality of artificial intelligence (AI) processing units (APU).

In one solution, a method of communication, comprising: generating, at a terminal device, assistant information associated with at least one of the following: first information used for adjusting a specification of a ML model being operated at the terminal device, or second information used for adjusting a specification of a multiple input multiple output (MIMO), the second information associated with at least one of the following: a measurement specification of the MIMO, a computation specification of the MIMO, or a maintenance specification of the MIMO; and transmitting, the assistant information to the network device.

In some embodiments, the assistant information is suggestive information, the method further comprises: receiving, from the network device, an adjust configuration to be used by the terminal device.

In some embodiments, the assistant information indicates an adjusted state which is currently valid at the terminal device.

In some embodiments, generating the assistant information comprises: generating the assistant information in response to defecting at least one of the following: a temperature of the terminal device increasing to a first threshold temperature, a temperature of the terminal device decreasing to a second threshold temperature, a power consumption of the terminal device increasing to a first threshold consumption, or a power consumption of the terminal device decreasing to a second threshold consumption.

In some embodiments, the method further comprise: starting a timer in response to applying the assistant information at the terminal device, falling back to a previous configuration in response to an expiration of the timer.

In some embodiments, the specification of the ML model is associated with at least one of the following: an input size of the ML model, an output size of the ML model, or a processing requirement of the ML model.

In some embodiments, the first information indicates at least one the following: a parameter used for stopping or enabling a training procedure of the ML model, a parameter used for stopping or enabling an interference procedure of the ML model, a parameter used for stopping or enabling a downloading procedure of the ML model, a parameter used for stopping or enabling an uploading procedure of the ML model, a parameter used for relaxing or enhancing a processing timing requirement for the interference procedure, a parameter used for reducing or increasing the number of ML processing resources of the ML model, a parameter used for switching the ML model to a lite ML model, or a parameter used for suspending or restoring a life-cycle management for the terminal device.

In some embodiments, the first information associated with at least one the following: a size of precoding matrix indicators (PMIs) for channel state information (CSI), as an input of the ML model, a size of channel matrix for CSI, as an input of the ML model, the number of measurement instances for the CSI, as an input of the ML model, the number of compressed bits for the CSI, as an output of the ML model, the number of prediction instances for the CSI, as an output of the ML model, the number of measurement beams or measurement instances for a beam management, as an input of the ML model, or the number of predicted beams or predicted instances for the beam management, as an output of the ML model.

In some embodiments, the second information indicates at least one the following: the number of reference signals (RSs) to be measured, the number of RSs to be reported, a transmission periodicity of RS, a report periodicity of RS, the number of receiver beams to be measured, the number of transmit beams to be measured, the number of transmit-receiver beam pairs to be measured, or the number of ports of RS.

In some embodiments, the second information indicates at least one the following: a processing time for physical downlink shared channel (PDSCH), a preparation time for physical uplink shared channel (PUSCH), a time offset between any two of a trigger of reference signal (RS), a transmission of RS, and a report of RS, a beam application timing, a beam switching timing, a time duration for quasi co-location (QCL), a computation time of channel state information (CSI), the number of machine learning (ML) processing resources for CSI, the number of activated transmission configuration indicator (TCI) states, the number of beams to be maintained, the number of path loss (PL) reference signal (RS) to be maintained, a depth of QCL chain.

In some embodiments, the second information indicates at least one the following: a duty cycle for uplink transmission, the number of sounding reference signal (SRS) resource sets, the number of panels used for uplink transmission.

In one solution, a method of communication, comprising: predicting at a terminal device, a temperature change in a subsequent period; determining assistant information if the temperature change meets a adjust condition, the assistant information used for relieving the temperature change in the subsequent period; and transmitting the assistant information to a network device.

In some embodiments, the assistant information is associated with at least one of the following: the temperature change, a cause associated with the temperature change, an amount of data to be transmitted, at least one transmission performance requirement in the subsequent period, first information used for adjusting a specification of a ML model being operated at the terminal devoice, second information used for adjusting a specification of a multiple input multiple output (MIMO), or third information for adjusting a performance for data transmission in the subsequent period.

In some embodiments, determining the assistant information comprises: obtaining the assistant information from a pre-defined configuration, the pre-defined configuration indicating a correspondence between a temperature change and at least one parameter set.

In some embodiments, determining the assistant information comprises: determining the assistant information by using a ML model.

In some embodiments, the assistant information is suggestive information, the method further comprises: receiving, from the network device, an adjust configuration to be used by the terminal device.

In some embodiments, the assistant information indicating an adjusted state which is currently valid at the terminal device.

In one solution, a method of communication, comprising: receiving, at a network device and from a terminal device, assistant information associated with at least one of the following: first information used for adjusting a specification of a ML model being operated at the terminal devoice, or second information used for adjusting a specification of a multiple input multiple output (MIMO).

In some embodiments, the assistant information is suggestive information, the method further comprises: generating, based on the assistant information, an adjust configuration to be used by the terminal device; and transmitting the adjust configuration to the terminal device.

In some embodiments, the assistant information indicating an adjusted state which is currently valid at the terminal device.

In some embodiments, the specification of the ML model is associated with at least one of the following: an input size of the ML model, an output size of the ML model, or a processing requirement of the ML model.

In some embodiments, the first information indicates at least one the following: a parameter used for stopping or enabling a training procedure of the ML model, a parameter used for stopping or enabling an interference procedure of the ML model, a parameter used for stopping or enabling a downloading procedure of the ML model, a parameter used for stopping or enabling an uploading procedure of the ML model, a parameter used for relaxing or enhancing a processing timing requirement for the interference procedure, a parameter used for reducing or increasing the number of ML processing resources of the ML model, a parameter used for switching the ML model to a lite ML model, or a parameter used for suspending or restoring a life-cycle management for the terminal device.

In some embodiments, the first information associated with at least one the following: a size of precoding matrix indicators (PMIs) for channel state information (CSI), as an input of the ML model, a size of channel matrix for CSI, as an input of the ML model, the number of measurement instances for the CSI, as an input of the ML model, the number of compressed bits for the CSI, as an output of the ML model, the number of prediction instances for the CSI, as an output of the ML model, the number of measurement beams or measurement instances for a beam management, as an input of the ML model, or the number of predicted beams or predicted instances for the beam management, as an output of the ML model.

In some embodiments, the specification of the MIMO is associated with at least one of the following: a measurement specification of the MIMO, a computation specification of the MIMO, or a maintenance specification of the MIMO.

In some embodiments, the second information indicates at least one the following: the number of reference signal (RS) to be measured, the number of RS to be reported, a transmission periodicity of RS, a report periodicity of RS, the number of receiver beams to be measured, the number of transmit beams to be measured, the number of transmit-receiver beam pairs to be measured, the number of ports of RS.

In some embodiments, the second information indicates at least one the following: a processing time for physical downlink shared channel (PDSCH), a preparation time for physical uplink shared channel (PUSCH), a time offset between any two of a trigger of reference signal (RS), a transmission of RS, and a report of RS, a beam application timing, a beam switching timing, a time duration for quasi co-location (QCL), a computation time of channel state information (CSI), the number of machine learning (ML) processing resources for CSI, the number of activated transmission configuration indicator (TCI) states, the number of beams to be maintained, the number of path loss (PL) reference signal (RS) to be maintained, a depth of QCL chain.

In some embodiments, the second information indicates at least one the following: a duty cycle for uplink transmission, the number of sounding reference signal (SRS) resource sets, the number of panels used for uplink transmission.

In one solution, a method of communication, comprising: receiving, at a network device, assistant information from a terminal device, the assistant information, wherein, the assistant information is transmitted by the terminal device in response to detecting a predicted temperature change meets a adjust condition and is used for relieving a temperature change of the terminal device in the subsequent period.

In some embodiments, the assistant information is associated with at least one of the following: the temperature change, a cause associated with the temperature change, an amount of data to be transmitted, at least one transmission performance requirement in the subsequent period, first information used for adjusting a specification of a ML model being operated at the terminal devoice, second information used for adjusting a specification of a multiple input multiple output (MIMO), or third information for adjusting a performance for data transmission in the subsequent period.

In some embodiments, the assistant information is suggestive information, the method further comprises: generating, based on the assistant information, an adjust configuration to be used by the terminal device; and transmitting the adjust configuration to the terminal device.

In some embodiments, the assistant information indicating an adjusted state which is currently valid at the terminal device.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2A to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
determining, at a terminal device supporting a plurality of machine learning (ML) models, the respective number of ML processing resources or a respective priority for each ML model of at least one ML model being operated at the terminal device based on at least one factor including the following:
a real-time requirement of the ML model,
a latency of the ML model,
a collaboration level of the ML model,
a report transmission requirement of the ML model,
a ML type of the ML model, the ML type being one of a two-sided ML model or a one-sided ML model,
the number of entities involved in the ML model,
a functionality of the ML model,
a ML group which the ML model belongs to,
an accuracy requirement of the ML model, or
a communication protocol layer associated with the ML model; and
scheduling, based on the respective numbers of ML processing resources or the respective priorities, ML processing resources for the at least one ML model.

2. The method of claim 1, wherein different factors of the at least one factor are configured with different weights.

3. The method of claim 1, wherein, determining the respective number of ML processing resources or the respective priority comprises:
determining the respective number of ML processing resources or the respective priority according to at least one rule, the at least one rule defining: a first priority of a first ML model is higher than a second priority of a second ML model or a first number of ML processing resources for the first ML model is larger than a second ML processing resources for the second ML model if at least one of:
the first ML model is a real-time ML model and the second ML model is a non-real-time ML model,
the first ML model requires a lower latency compared with the second ML model,
the first ML model requires a higher collaboration level compared with the second ML model,
the first ML model requires a higher accuracy compared with the second ML model,
an ML type of the ML model of the first ML model is two-sided ML model, and an ML type of the ML model of the second ML model is one-sided ML model,
the number of entities involved in the first ML model is larger than the number of entities involved in the second ML model,
the first ML model requires a report transmission, and the second ML model does not require a report transmission,
the first ML model requires a higher accuracy compared with the second ML model,
a communication protocol layer associated with the first ML model is lower than a second communication protocol layer associated with the second ML model, or
the first ML model is a communication-related ML model and the second ML model is a communication-irrelevant ML model.

4. The method of claim 1, further comprising:
suspending an update procedure for a subset of the at least one ML model according to the respective priorities.

5. The method of claim 4, wherein the number of the subset of the at least one ML model is determined based on at least one of the following:
a maximum number of ML processing resources supported by the terminal device,
the number of the at least one ML model, or
the respective number of ML processing resources occupied by each of the at least one ML model during a period.

6. The method of claim 1, when determining the respective number of ML processing resources for each ML model of at least one ML model, the at least one factor further comprises:
an input size of the ML model,
an output size of the ML model,
a structure of the ML model, or
a stage of life-cycle management at which the ML model is currently operated.

7. The method of claim 1, further comprising:
transmitting, to a network device, a maximum ML processing capability supported by the terminal device.

8. A method of communication, comprising:
generating, at a terminal device, assistant information associated with at least one of the following:
first information used for adjusting a specification of a ML model being operated at the terminal device, or
second information used for adjusting a specification of a multiple input multiple output (MIMO), the second information associated with at least one of the following:
a measurement specification of the MIMO,
a computation specification of the MIMO, or
a maintenance specification of the MIMO; and
transmitting, the assistant information to the network device.

9. The method of claim 8, wherein generating the assistant information comprises:
generating the assistant information in response to defecting at least one of the following:
a temperature of the terminal device increasing to a first threshold temperature,
a temperature of the terminal device decreasing to a second threshold temperature,
a power consumption of the terminal device increasing to a first threshold consumption, or
a power consumption of the terminal device decreasing to a second threshold consumption.

10. The method of claim 8, wherein the specification of the ML model is associated with at least one of the following:
an input size of the ML model,
an output size of the ML model, or
a processing requirement of the ML model.

11. The method of claim 8, wherein the first information indicates at least one the following:
a parameter used for stopping or enabling a training procedure of the ML model,
a parameter used for stopping or enabling an interference procedure of the ML model,
a parameter used for stopping or enabling a downloading procedure of the ML model,
a parameter used for stopping or enabling an uploading procedure of the ML model,
a parameter used for relaxing or enhancing a processing timing requirement for the interference procedure,
a parameter used for reducing or increasing the number of ML processing resources of the ML model,
a parameter used for switching the ML model to a lite ML model, or
a parameter used for suspending or restoring a life-cycle management for the terminal device.

12. The method of claim 8, wherein the first information associated with at least one the following:
a size of precoding matrix indicators (PMIs) for channel state information (CSI), as an input of the ML model,
a size of channel matrix for CSI, as an input of the ML model,
the number of measurement instances for the CSI, as an input of the ML model,
the number of compressed bits for the CSI, as an output of the ML model,
the number of prediction instances for the CSI, as an output of the ML model,
the number of measurement beams or measurement instances for a beam management, as an input of the ML model, or
the number of predicted beams or predicted instances for the beam management, as an output of the ML model.

13. The method claim 8, wherein the second information indicates at least one the following:
the number of reference signals (RSs) to be measured,
the number of RS to be reported,
a transmission periodicity of RS,
a report periodicity of RS,
the number of receiver beams to be measured,
the number of transmit beams to be measured,
the number of transmit-receiver beam pairs to be measured, or
the number of ports of RS.

14. The method claim 8, wherein the second information indicates at least one the following:
a processing time for physical downlink shared channel (PDSCH),
a preparation time for physical uplink shared channel (PUSCH),
a time offset between any two of a trigger of reference signal (RS), a transmission of RS, and a report of RS,
a beam application timing,
a beam switching timing,
a time duration for quasi co-location (QCL),
a computation time of channel state information (CSI),
the number of machine learning (ML) processing resources for CSI,
the number of activated transmission configuration indicator (TCI) states,
the number of beams to be maintained,
the number of path loss (PL) reference signal (RS) to be maintained, or
a depth of QCL chain.

15. A method of communication, comprising:
predicting at a terminal device, a temperature change in a subsequent period;
determining assistant information if the temperature change meets a adjust condition, the assistant information used for relieving the temperature change in the subsequent period; and
transmitting the assistant information to a network device.

16. The method of claim 15, wherein the assistant information is associated with at least one of the following:
the temperature change,
a cause associated with the temperature change,
an amount of data to be transmitted,
at least one transmission performance requirement in the subsequent period,
first information used for adjusting a specification of a ML model being operated at the terminal devoice,
second information used for adjusting a specification of a multiple input multiple output (MIMO), or
third information for adjusting a performance for data transmission in the subsequent period.

17. A method of communication, comprising:
receiving, at a network device and from a terminal device, assistant information associated with at least one of the following:
first information used for adjusting a specification of a ML model being operated at the terminal devoice, or
second information used for adjusting a specification of a multiple input multiple output (MIMO).

18. A method of communication, comprising:
receiving, at a network device, assistant information from a terminal device, the assistant information,
wherein, the assistant information is transmitted by the terminal device in response to detecting a predicted temperature change meets a adjust condition and is used for relieving a temperature change of the terminal device in the subsequent period.

19. A communication device comprising:
a processor; and
a memory coupled to the processor and storing instructions thereon, the instructions, when executed by the processor, causing the communication device to perform the method according to any of claims 1-18.

20. A computer readable medium having instructions stored thereon, the instructions, when executed on at least one processor, causing the at least one processor to perform the method according to any of claims 1-18.
